(19) United States
(12) Patent Application Publication
(10) Pub. No.: US 2002/0087408 A1
(43) Pub. Date: Jul. 4, 2002

(54) System for providing information to intending consumers

(76) Inventor: Jonathan Robert Burnett, Eastwood (AU)

Correspondence Address: Ajay A. Jagtiani, Jagtiani + Guttag, Democracy Square Business Center, 10379-B Democracy Lane, Fairfax, VA, 22030, US

(21) Appl. No.: 10/023,856

(22) Filed: Dec. 21, 2001

(30) Foreign Application Priority Data
Jun. 5, 2001 (AU) 50132/01
Jun. 23, 2000 (AU) PCT/AU00/00721
Jun. 25, 1999 (AU) PQ1198
Nov. 30, 1999 (AU) PQ4356

(51) Int. Cl. G06F 17/60

(52) U.S. Cl. 705/14

(57) ABSTRACT

The product information distribution system (20) comprises:

a database (8) having records of user purchasable products, each of the records including fields for at least identification and geographical availability of a product,

an input means (15) for receiving input data from a user related to a preferred product which is selected from one of said product identification fields of said records, a distance value and a preferred geographical location from which the preferred product is to be sourced,

searching means (7) for searching the database according to the input data and for determining a search result, the search result relating to those of the records including products meeting the product identification fields and available within a boundary determined by the distance value of the preferred geographical location, and

an output display means (14) for displaying the search result to the user.

### TECHNICAL FIELD OF THE INVENTION

The present invention relates to a computerised system for providing information to intending consumers of various commodity products and/or services.

### BACKGROUND ART

Consumers of commodity products and/or services are often interested in obtaining specific, relevant information about their intending purchase. The process of seeking such information prior to making a purchase is sometimes referred to as “pre-shopping”. There are two aspects to the concept of pre-shopping. One is the search for product information and the other is the search for retailer information. This is because consumers generally ask themselves two questions when pre-shopping: “What product meets my requirements?” and “Where can I buy it?”

The methods available for an intending consumer to obtain this information can be divided into:

(i) “Offline”—in the traditional, physical sense, and

(ii) “Online”—using the Internet based World Wide Web (“WWW’).

The Internet continues to grow in popularity as it provides users with a considerable amount of information which is available on demand. The introduction of the Internet has meant the process of pre-shopping, which was previously done on an ad-hoc basis, has become more systematic with the greater availability of information. Existing Internet pre-shopping facilities, however, tend to provide either a product search or a retailer search, but not both.

Product Selection:

The goal in product selection is to answer the consumer's question: “What product meets my requirements?” This involves identifying the products that meet specific criteria and possibly comparing similar products.

Offline Pre-shopping for Product Information:

One known method in which an intending consumer can obtain product information “offline” is through browsing various media, such as newspapers and magazines for advertisements that have been placed by retailers or suppliers. Advertisements can also appear in these media as classified listings.

Another method in which an intending consumer can obtain the relevant information “offline” is through accessing test reports and the like, which are published in magazines or other publications associated with consumer interest groups. Both media advertisements and technical brochures can be limited in their usefulness and the consumer must spend time collecting and comparing the information which may be unavailable or out of date. Printed brochures are also limited in their space, and hence are also content limited, whilst also being expensive for retailers to produce and distribute.

Another method by which an intending consumer can obtain the relevant information “offline” is through locating and directly contacting or attending a store that sells the type of product being selected. Simply locating a relevant retailer presents problems on its own, which are considered below. Once an intending consumer has located a retailer they may not always be able to obtain the information they are seeking by attending the retail store. Printed product information may be unavailable or out of date, knowledgeable sales staff may not be available or the retail store may not be open at times convenient to the consumer.

Online Pre-shopping for Product Information:

The product search facilities that are currently available to consumers using the Internet can be divided into four broad categories: search engines, web directories, product comparison services and supplier websites.

Generic search engines include web sites such as Google(™) (google.com) and Alta Vista(™) (altavista.com). These search engines accept a keyword from the intending consumer and then return a list of websites that contain the keyword, with a brief synopsis of each website. Each search engine has its own mechanism for ranking the results but in general the results cannot be sorted by the user who must visit each suggested website individually to ascertain the relevance of the information contained in that website.

Web directories, such as Yahoo! (™) (yahoo.com) and LookSmart(™) (looksmart.com), use a hierarchical system to classify web pages according to pre-determined categories which users are able to browse through. Some systems support keyword searching across all pages and some provide a keyword search which is restricted to a subset of pages. Search results are presented as a single list or grouped according to hierarchy categories, however the user must still visit each suggested website individually to obtain the required information.

Examples of product specific search and comparison websites include automotive comparison sites, such as Drive(™) (drive.com.au), and real estate search sites, such as realestate.com.au or property.com.au. Some on-line retailers, such as Amazon.com, provide product specific search facilities to assist consumers to browse within their website. Most web based product search facilities are based on fixed web pages, with predetermined search fields that are determined by the particular product featured. The majority of these product search facilities use forms that are specifically designed and only handle a particular type of product. For example, real estate search facilities have forms that include fields corresponding to features related to houses (such as number of bedrooms), but these forms cannot be used to search for a car. In these systems, any changes made to the underlying database, such as the inclusion of a new feature, will require changes to the forms used to query the database and to present the results. Search results can sometimes be ranked by limited criteria, such as price. There may also be a facility for comparison of products, although this is usually limited to only two or three products at a time.

Information about products can usually be found on the corresponding suppliers' website. Intending consumers will often have a short list of preferred brand names they will consider and they may go directly to the website associated with that brand in order to obtain more information on their products. Usually a consumer will need to browse through the website to obtain the information they are seeking. Some suppliers' websites include a limited keyword search facility.

The majority of existing Internet based product search systems rely on some form of keyword matching to locate possible products. There are many problems with systems that rely on keyword matching, including:

reliance on consumer “guessing” the same keyword used by the product definer,

inability to handle synonyms, spelling mistakes or abbreviations, and

ambiguity caused by lack of context for the supplied keyword.

These problems can make it difficult to locate potentially relevant products, but the main problem confronting consumers is the difficulty of using keywords to refine a search. Even with systems that support “keyword algebra” it is often difficult to completely specify the required features.

Retailer Selection:

A consumer that has selected a specific product, or has prepared a short list of acceptable alternatives, will generally want to know where they can buy them and how much they will cost. They will want to know the availability and pricing of the desired product or service, preferably from several retailers so that comparisons can be made. In selecting a preferred retailer they may want to consider the retailer's location (physical or online address), the retailer's operating hours (if relevant) and the available payment options. The traditional source of this information is business directories, such as the Yellow Pages. On the Internet the sources of retailer information include business directories, reseller locators and bots or agents.

Offline Business Directories:

Traditional business directories list businesses according to the type of product or service they provide. They are not necessarily able to confirm if a retailer stocks a particular brand or model. Because they are printed books, each listing is allocated a finite space which limits the amount of information that can be provided. They are also generally only printed once a year so information can be outdated and difficult to update. Although there is the opportunity for suppliers or retailers to pay for an expanded listing this does not significantly increase the information provided. The consumer must still telephone or otherwise enquire of the retailer to obtain further information such as product availability, pricing, trading hours or available payment options.

Online Business Directories:

Online business directories, such as the online version of the Yellow Pages(™) (yellowpages.com) have the advantage over their offline equivalents of being more up to date and easier to search. Most online business directories provide keyword search or searches by product type. They do, however, present similar limitations to their offline equivalents in terms of the amount of information provided. Many existing business directory systems limit the ability of a consumer to differentiate between retailers. Some systems simply provide a list of retailers, with no mechanism for refining the list. Some location filtering systems rely on post code matching, others are constrained by the boundaries of a telephone directory. Few systems support additional criteria for refining a list and even those that do, rely on keyword matching rather than providing the consumer with a list of the specific values that are available.

Online Reseller Locators:

Reseller locators generally appear on supplier websites. They will list retailers that sell a particular brand of product but will not be able to confirm that the retailer stocks the particular model the consumer wants to buy. Suppliers tend to also list only their authorised or preferred resellers so the consumers may not necessarily obtain a comprehensive listing.

Online Bots or Agents:

Internet shopping ‘bots’ and ‘agents’, such as MySimon(™) (mysimon.com), use computer programs to source and consolidate information from various retailer websites. Many existing shopping ‘bot’ or ‘agent’ systems rely exclusively on information that is already on the web. They have difficulty providing a consistent interface to the consumer because all the information is stored in different formats. Retailers dislike these systems because they tend to extract only the core pieces of information (such as price) from individual websites and do not provide other information that may assist the consumer to make an informed decision.

Existing Internet search methods are generally only able to locate products that are available for purchase ‘on-line’ and are generally restricted to products that are suitable for delivery by mail or other courier mechanism. This limits the types of products that can be efficiently handled by the existing methods.

It is an object of the present invention to provide a means for providing information to intending consumers of commodity products and/or services and to at least ameliorate one or more shortcomings of the prior art.

### SUMMARY OF THE INVENTION In accordance with one aspect of the present invention, there is provided a product information distribution system comprising:

a database having records of user purchasable products, each said record including fields for at least identification and geographical availability of said product,

an input means for receiving input data from a user related to a preferred product which is selected from one of said product identification fields of said records, a distance value and a preferred geographical location from which said preferred product is to be sourced,

searching means for searching said database according to said input data and for determining a search result, said search result relating to those of said records including products meeting said product identification fields and available within a boundary determined by said distance value of said preferred geographical location, and

an output display means for displaying said search result to said user.

In accordance with another aspect of the present invention there is provided a computerised system comprising:

an input means for receiving input data including a user-selected market entity, a reference geographical location, and a maximum deviation from said reference geographical location,

an output means for displaying information to the user, and

a memory means including an executable user-interface program for operatively controlling said input means and said output means, a database of records including an identity and geographical availability for each of a plurality of market entities, and an executable searching program for searching said database for records that correlate with said input data and for enabling said records that correlate to be displayed as information on said output means.

In accordance with still another aspect of the present invention there is provided a method of facilitating Internet-assisted commerce, said method comprising the steps of:

collecting a plurality of retailer related records, each of said retailer related records including a product code, and a related geographical availability in longitudinal and latitudinal form,

storing said plurality of retailer related records in searchable form,

providing a means for selectively retrieving one or more particular retailer related records based upon a user entered product code and a maximum allowed deviation from said geographical availability.

In accordance with another aspect of the present invention there is provided a system for distributing information related to user purchasable products, said system comprising:

database of records including fields related to identification, pricing, characterisation and geographical availability of a plurality of user purchasable products, said records also including fields related to a plurality of suppliers of the user purchasable products,

input means for receiving user input data related to at least a desired characterisation and geographical availability of a desired user purchasable product,

searching means for searching said database on the basis of said user input data and for determining a search result, said search result having records including said fields related to identification, pricing and supplier, and

an output display means for displaying said search result.

In accordance with another aspect of the present invention there is provided a computerised method of distributing product information, said method comprising the steps of:

tendering a plurality of product for selection of one desired product type by the user,

tendering at least one or more relevant characterising product attributes, on the basis of the selected product type, for selection of one or more attribute preferences by the user,

obtaining geographical data related to an acceptable geographical purchasing area by the user, and

returning any of a plurality of pre-stored data records which correlate to all of said selections and said acceptable geographical purchasing area.

In accordance with another aspect of the present invention, there is provided a method of dynamically constructing a searchable index of valid identifiers, said method comprising the steps of:

(i) prompting a user for an initial word;

(ii) building a set of possible valid identifiers based on said initial word and previously mapped relationships with respect to said initial word;

(iii) displaying said set for selection by the user,

(iv) adding the initial word to a list of unmatched words, prompting the user for a new initial word and repeating from step (ii), if a selection from said set has not been made by the user;

(v) providing a further mapped relationship for each of said list of unmatched words with a selected valid identifier, if a selection from said set is made by the user.

In accordance with another aspect of the present invention, there is provided an indexing system comprising:

means for obtaining an initial word of interest;

a database for storing words and any related alternative words, each of said stored words being searchable on the basis of a mapped relationship with the initial word of interest; and

means for mapping and storing newly related words to said database where a search of the database cannot be determine a mapped relationship with the initial word of interest.

In accordance with another aspect of the present invention, there is provided a method for classifying information related to a plurality of identified entities, said method comprising the steps of:

creating a uniquely identifiable record of information related to each of said entities;

determining a rule for tagging each of said records, said rule including assignment of at least two indexable tags for each of said records; and

searching for one or more of said indexable tags on the basis of desired values of said indexable tags.

In accordance with another aspect of the present invention, there is provided a method for classifying and subsequently retrieving product related information, said method comprising the steps of:

displaying a product pick list to an intending consumer,

receiving a product selection from said product pick list from the intending consumer,

determining a set of attribute fields associated with said product selection,

displaying an attribute field pick list to the intending consumer,

receiving an attribute field selection and a value for one or more of said attribute fields,

determining product related information in accordance with said received selection and value, and

displaying said product relation information.

In accordance with another aspect of the present invention, there is provided a method of preparing an instruction for querying a database holding records of information related to marketable entities, said method comprising the steps of:

keying a command as an input text message into a wireless mobile device; and

communicating said command to said database including the use of wireless transmission,

wherein context data is incorporated into said command to prepare said instruction.

In accordance with another aspect of the present invention, there is provided a system for distributing information to consumers related to market entities, said system comprising:

input means for receiving input query information from a consumer related to a preferred market entity;

adjustment means for adjusting said input query information with one or more instances of context information to create input data;

searching means for searching a database of records for matches that correlate with said input data, and

output means for outputting said matches,

wherein a path for communicating said input query information or said input data between said input means and said searching means via said adjustment means, includes a wireless communication path.

In accordance with another aspect of the present invention, there is provided a method of preparing a command for inputting to a digital computer, said method comprising the steps of:

(a) receiving and storing an input character;

(b) scanning a set of valid abbreviations for a match with said character;

(c) repeating steps (i) and (ii) until a match is found;

(d) correlating said match with a keyword and constructing said command including at least said keyword; and

(e) transmitting said command over a wireless network to the digital computer.

In accordance with another aspect of the present invention, there is provided a computerised system comprising:

an input means for receiving input data including a user-selected market entity, at least one reference geographical location, and a time of day;

an output means for displaying information to the user, and

server means including an executable user-interface program for operatively controlling said input means and said output means, a database of records including an identity and geographical availability for each of a plurality of market entities, and an executable searching program for searching said database for records that correlate with said input data and for enabling said records that correlate to be displayed as information on said output means.

In accordance with another aspect of the present invention, there is provided a method of defining a geographical area for computerised searching of market entities, said method comprising the steps of:

defining a pair of geographical reference locations;

determining a distance value being greater than a linear distance between said pair of geographical reference locations; and

defining said geographical area by applying a rule that excludes entities that have a sum of a distance to each of said reference locations being greater than said distance value.

In accordance with another aspect of the present invention, there is provided a product information distribution system comprising:

a database having a record for each of a plurality of user purchasable products, each said record including fields for at least identification and geographical availability of said corresponding product,

input means for receiving input data from a user related to a preferred product which is selected from one of said product identification fields of said records, a distance value and two user input geographical locations from between which said preferred product is to be sourced,

searching means for searching said database according to said input data and for determining a search result, said search result relating to those of said records including products meeting said product identification fields and available within a boundary determined by the method according to an above method, and

an output means for displaying said search result to said user.

In accordance with another aspect of the present invention, there is provided a method of identifying entities of interest according to their geographical location, said method comprising the steps of:

defining at least two geographical reference locations;

determining a geocell enclosing said at least two reference locations;

determining an elliptically shaped region being within said geocell and including each of said at least two locations; and

identifying entities of interest from within said region.

Several advantages arise from the ability of the product information distribution system to perform a search based on the matching between the intending consumer's selection of pre-defined attributes (rather than key-words) of the desired product or service (“market entity”), and those records on a dedicated database that are stored in a format that is common for all participants who are usually a retailer or supplier/manufacturer. These advantages include:

(a) The intending consumer's ability to specify a specific product and/or service, and if necessary refine the search criteria based on preferred attributes, is enhanced over prior art key-word matching, and

(b) The intending consumer's ability to perform comparisons of price, value, availability, and other parameters of various commodity products and/or services, is enhanced over prior art key word matching, the results of which tend to make such a task difficult and/or time consuming.

Several advantages arise from the ability of the product information distribution system to perform a search based upon retail outlets located within a specified geographical area:

(a) Products and services can be advertised on-line that had previously not been available on-line, since existing on-line shopping is usually restricted to products that are able to be delivered by mail, courier and the like. The products not suitable for delivery include for example, low value items, bulky items, or heavy items. Without this restriction, goods which, because of their nature dictate that the customer receive the goods in person, can also be offered. This could include goods such as petrol, groceries, hot food, clothing etc. This could also include services, such as automatic teller machines where it is desired for the consumer to know where the service outlet is located.

(b) The retailer of goods which are “ordinarily” purchased (as distinct to “on-line” purchased) can provide additional, computerised information and support for their customers which they previously may not have been able to offer.

The product information distribution system has particular application for Internet-assisted shopping by consumers who intend to purchase and/or take delivery of the desired commodity product or service from a physical retail outlet.

### BRIEF DESCRIPTION OF THE DRAWINGS

Various arrangements of the present disclosure will now be described with reference to the drawings, in which:

FIG. 1 is a system block diagram of the main components required to implement a system for providing information to intending consumers,

FIG. 2 is a flow chart explaining the operation of the system for providing information to intending consumers,

FIG. 3 is a diagram of data types used in a database of the system for providing information to intending consumers,

FIG. 4 is a flow chart explaining the operation of an alternative method for obtaining the desired product selection from the user, being a series of alternative substeps referred to herein as “Smart Indexing System”,

FIGS. 5A to 5L is a series of display screen representations that could appear to a user when operating the system for providing information to intending consumers,

FIGS. 6A to 6C is another series of display screen representations used when operating another version of the system for providing information to intending consumers,

FIG. 7 is a system block diagram of the main components required to implement a Context Based SMS Directory Facility,

FIG. 8 is a flow chart for explaining the operation of the Context Based SMS Directory Facility,

FIG. 9 is a flow chart for explaining the operation of an Elliptical Spatial Search Facility,

FIG. 10 is a diagrammatical explanation associated with the method of FIG. 9, and

FIG. 11 is a further diagrammatical explanation associated with the method of FIG. 9.

### DETAILED DESCRIPTION INCLUDING BEST MODE

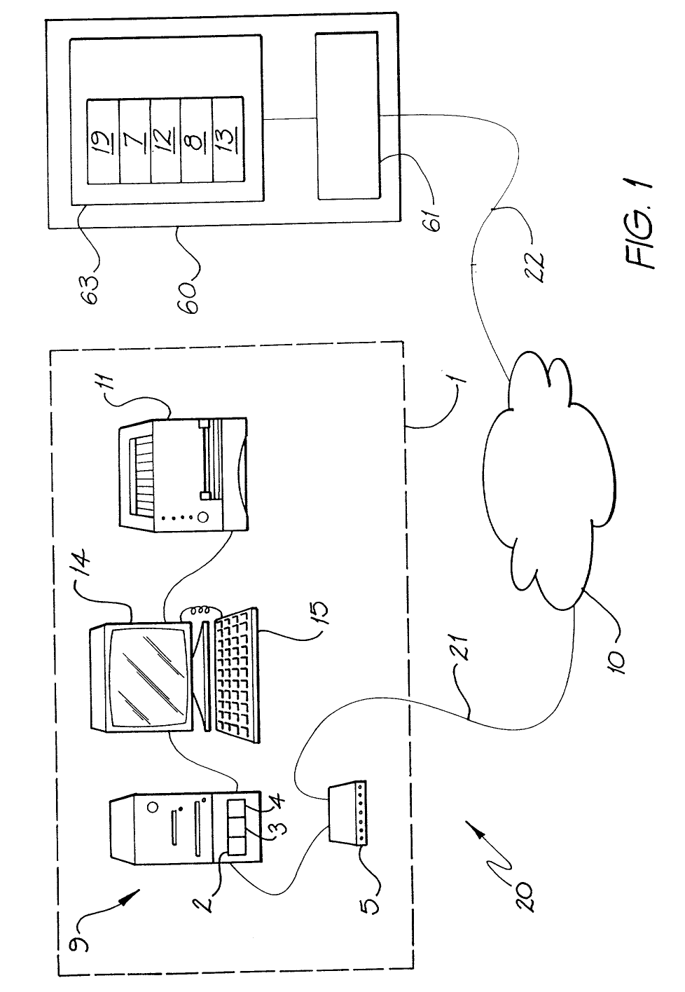

Referring to FIG. 1, a system 20 for providing information to intending consumers includes a collection of consumer-owned equipment 1 connected by a telephone line 21 to a computer network 10, which is in turn connected by a network cable 22 to a host computer 60 operated by a central administrator.

In the context of this description, the ambit of “information to intending consumers” includes the provision of information both to assist intending consumers with their purchasing decisions, and in the form of advertisements.

The consumer-owned equipment 1 includes a desktop personal computer (PC) 9, typically connected to each of a printer 11, a monitor 14, a keyboard 15 and a modem 5 to provide access to the computer network 10, which in this case is the Internet. The PC 9 is loaded with software programs including a WWW browser 2, a browser controller 3 and network or Internet connection software 4.

The host computer 60, which is connected to the Internet 10, includes a web server 61 for communication with each of the consumer owned equipment 1 via Hypertext Transfer Protocol (HTTP), and the applications server 63 via Common Gateway Interface (CGI) protocol.

The applications server 63 includes a user-interface memory area 19, a user interface program 12, a searching program 7, a database 8, a executable database retrieval program 8a (e.g., “Access” or “Oracle”), a specialised spatial searching application 13a (eg. “Map Info”), a geographical data conversion program 13 (eg. “GeoLoc”), an administration-interface memory area 25 and an administration interface program 26.

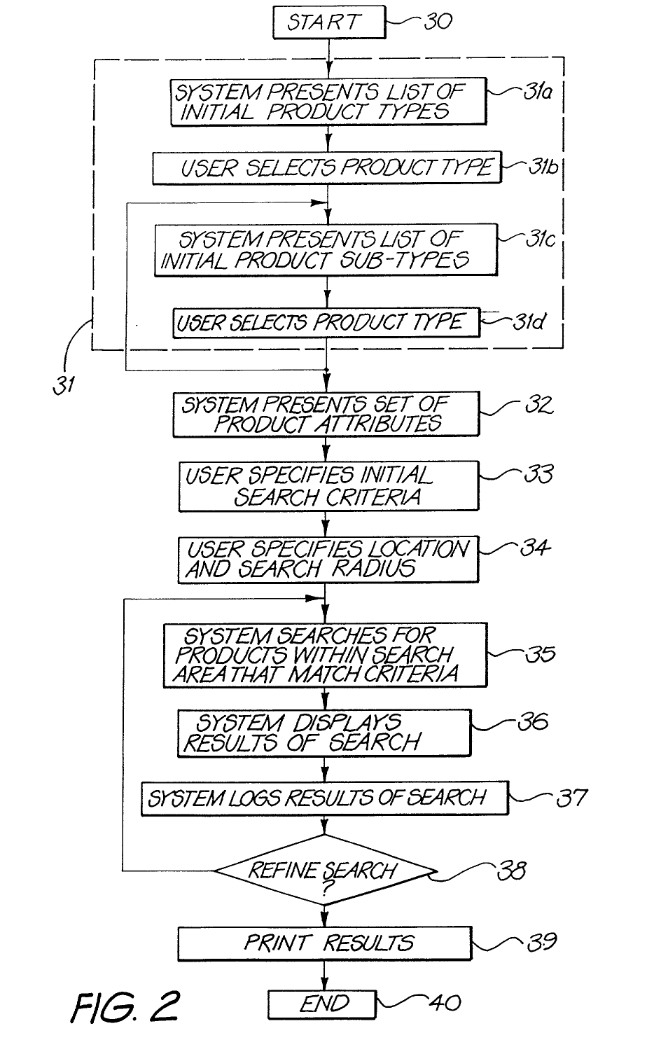

FIG. 2 shows a method 30 for providing information related to various goods and services, using the system 20 described in relation to FIG. 1 and commences with a start step 30 at which the user interface program 12 on the applications server 63 is executed.

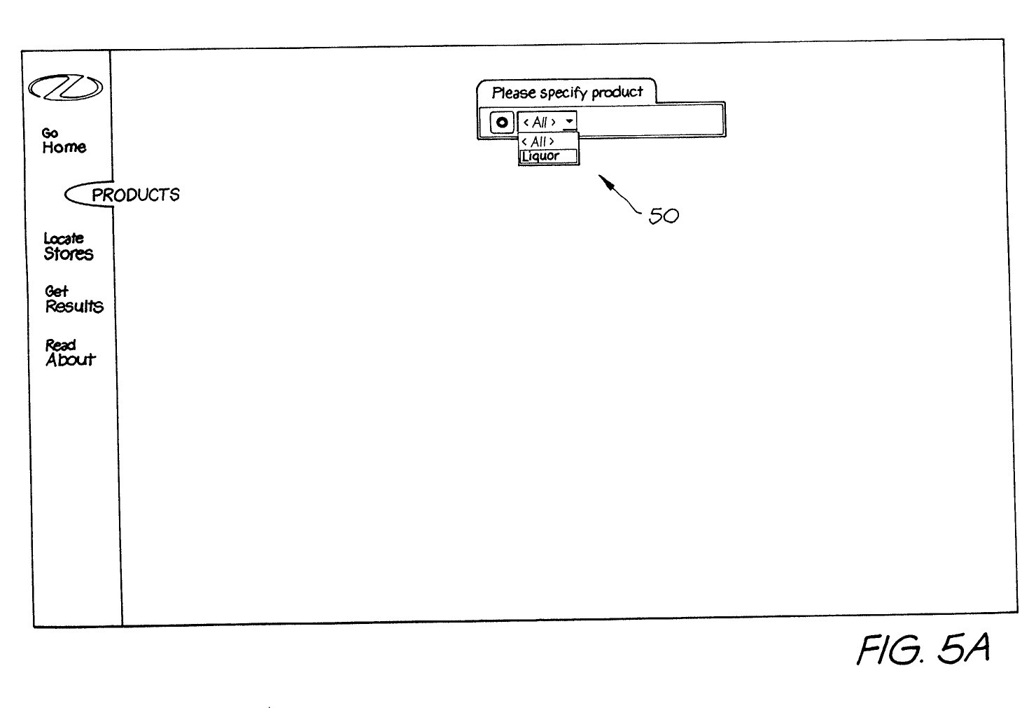

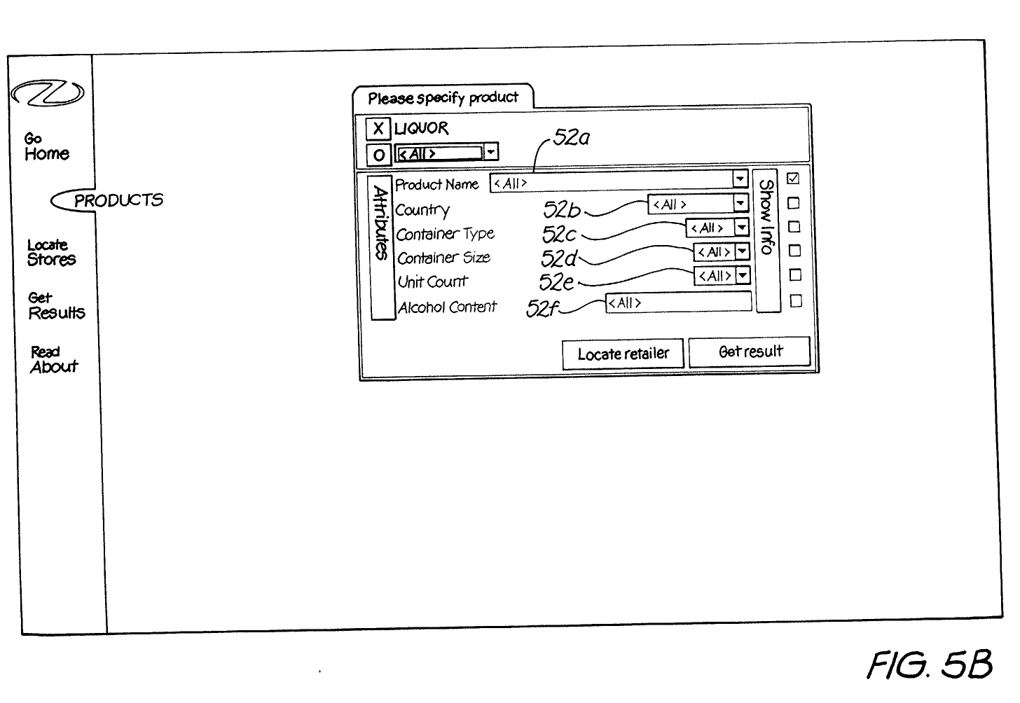

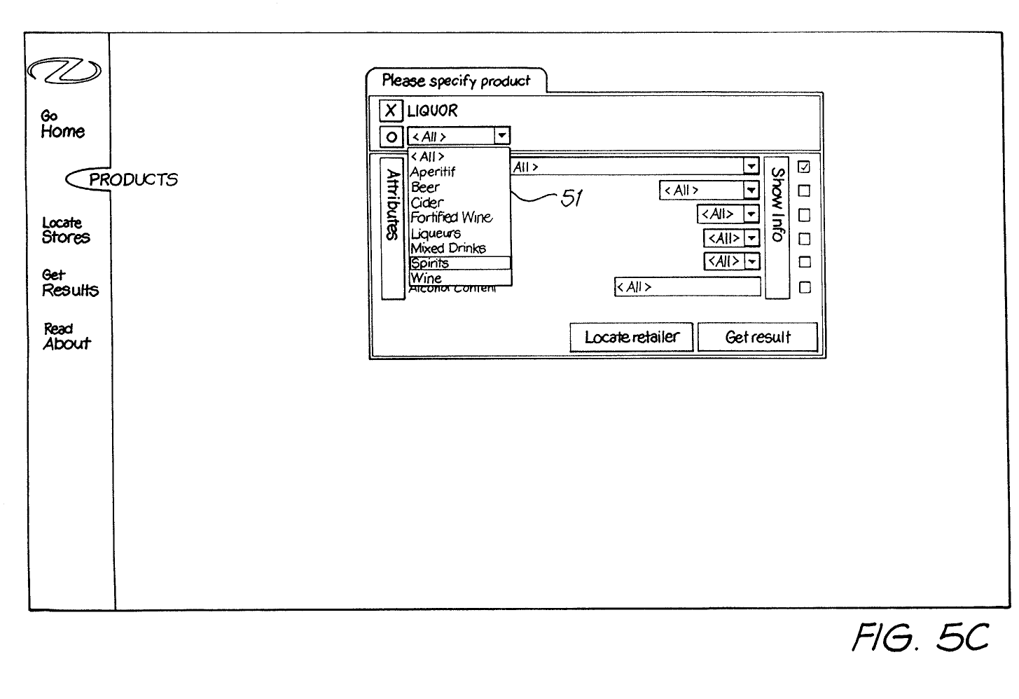

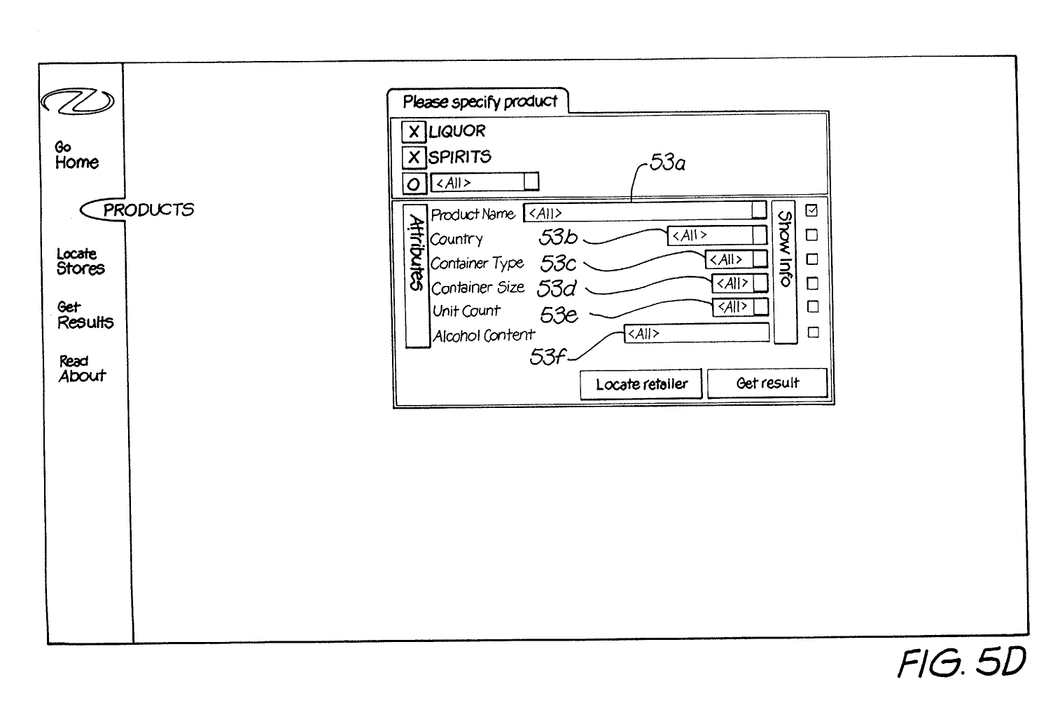

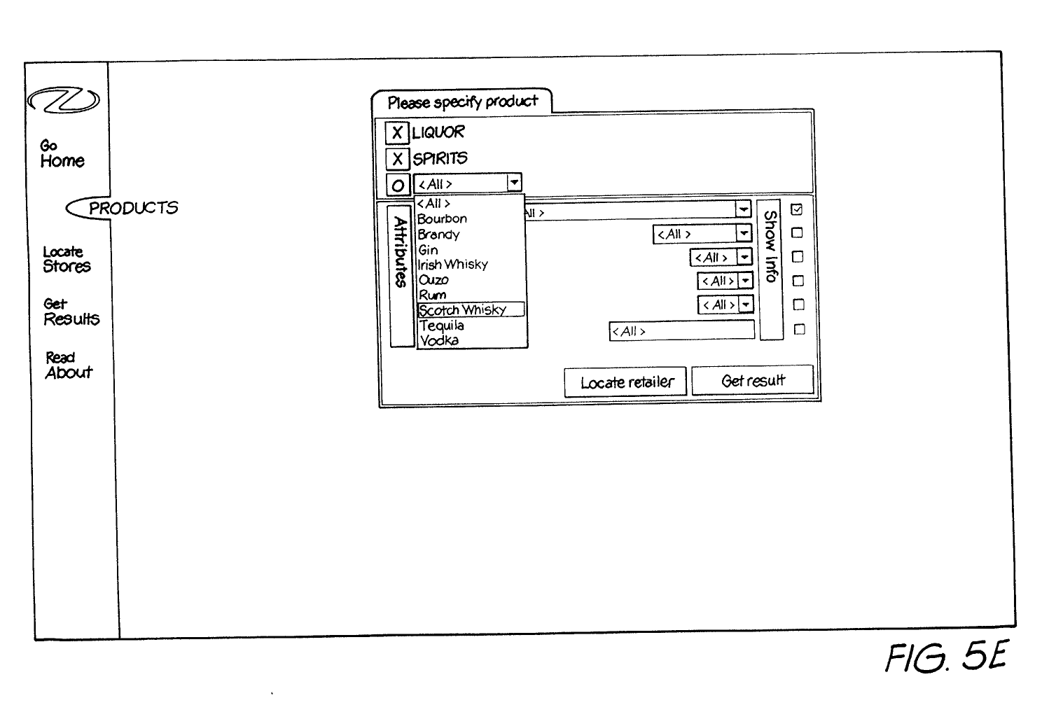

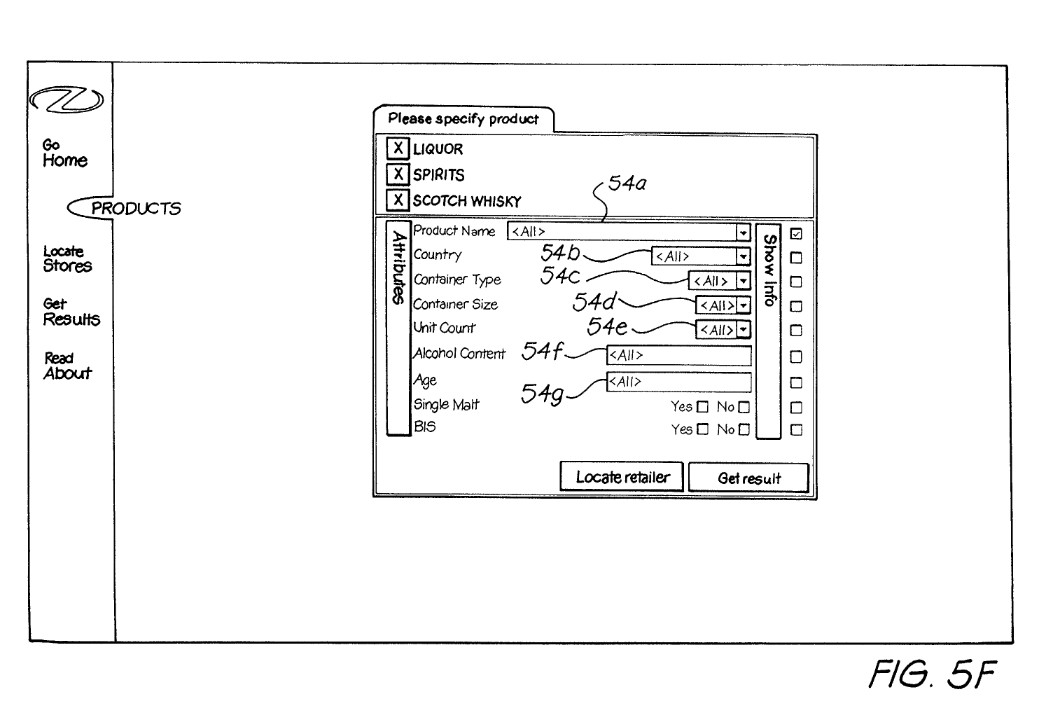

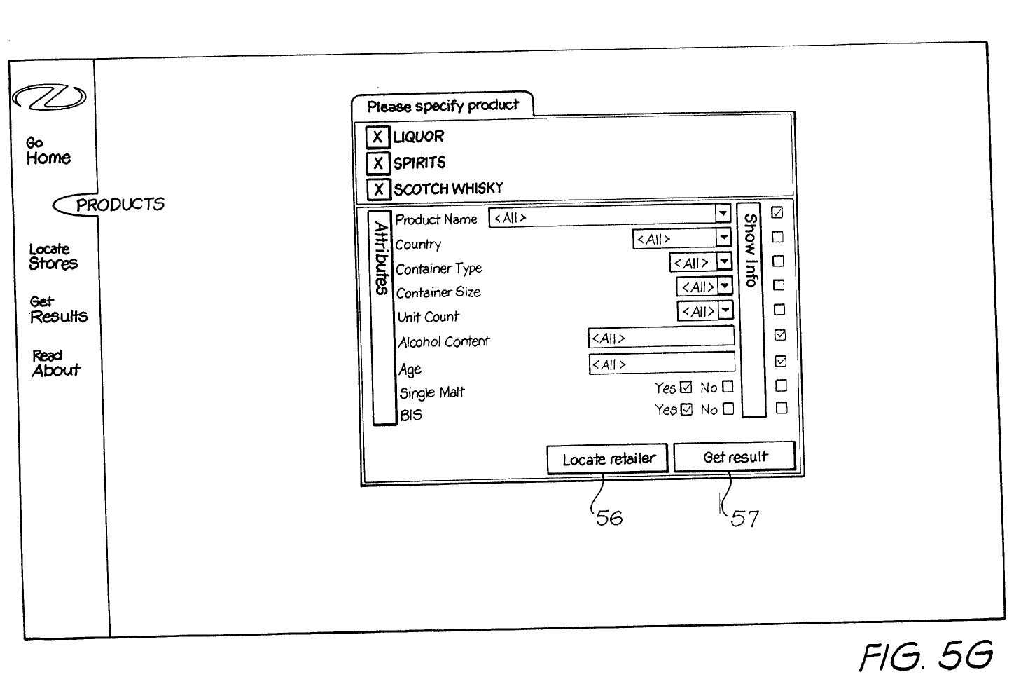

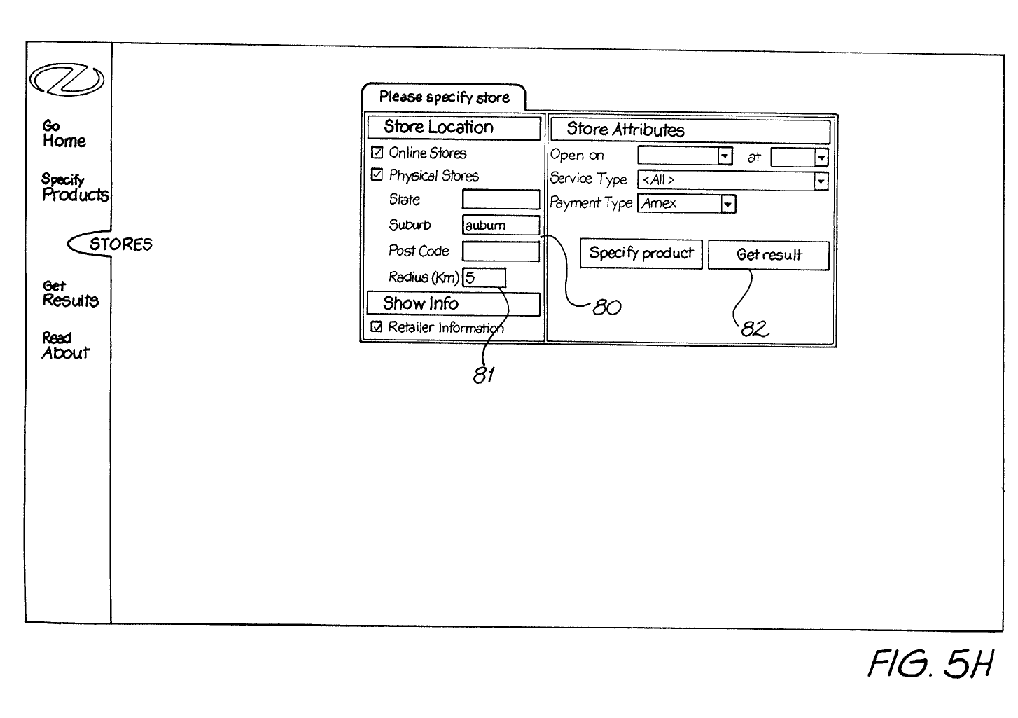

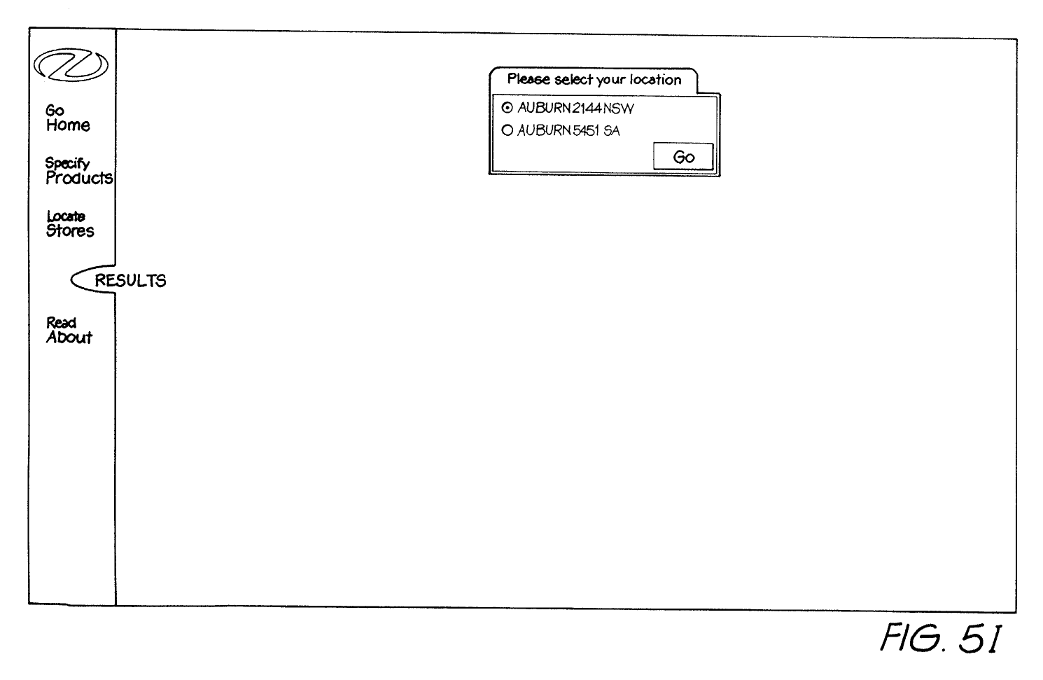

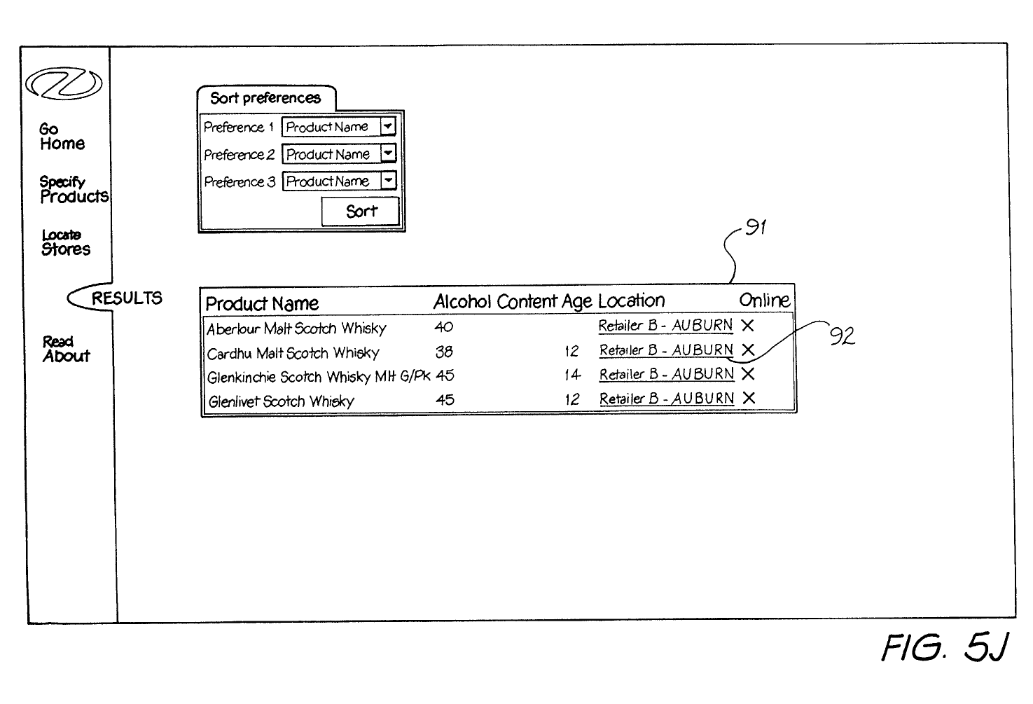

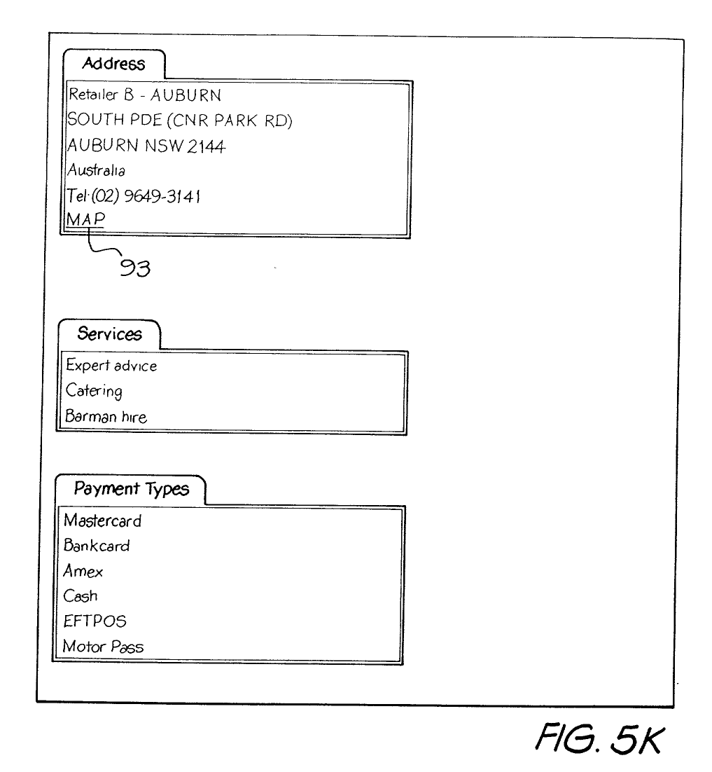

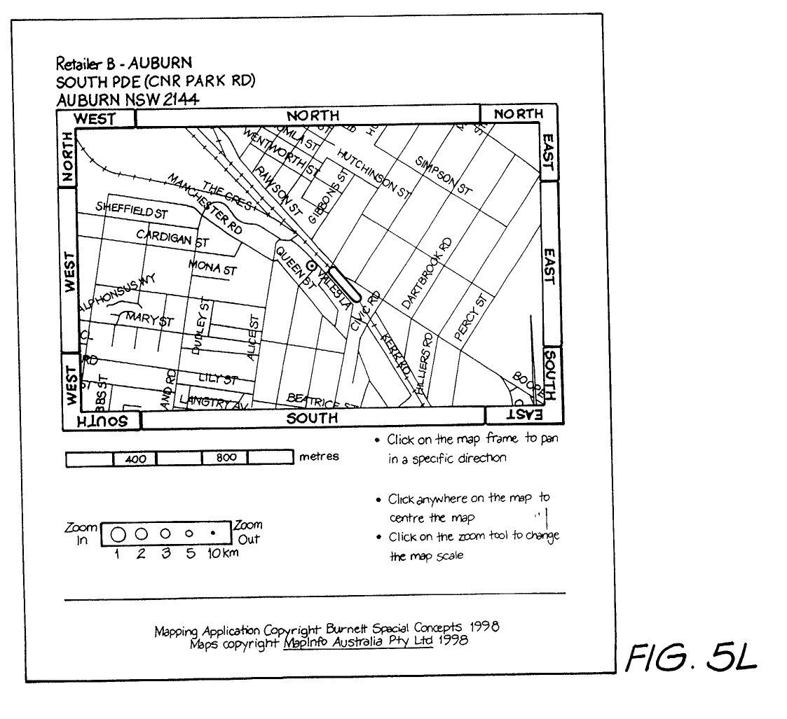

Reference is also made to the display screen representations of FIGS. 5A to 5M for this example.

In step 31, the initial product type is selected by the intending consumer and entered into the PC 1. In one example, step 31 includes the following sub-steps.

In sub-step 31a, the intending consumer is prompted by the PC 1 using a menu displayed on an output means, which in this case is the monitor 14, to make a selection from an initial “Product Type Pick List”. Referring to FIG. 5A, an example of a display screen which is presented to the intending consumer is shown. In FIG. 5A, the “Product Type Pick List” is in the form of a drop-down menu 50.

In sub-step 31b, the intending consumer enters data corresponding to a selected product type into the input means of the PC 1, which in this case is the keyboard 15.

For the purpose of illustration in this description, an example of an initial product type could be “liquor”, taken from an initial “Product Type Pick List” having for example, “liquor”, “services”, “petrol”, “motor vehicles” and “fast food”.

In sub-step 31c, the intending consumer is prompted to select a product sub-type from another “Product Pick List”, which is generated (to be described later) by the system and is based on the earlier selected product type. Referring to FIG. 5C, an example of a display screen which is presented to the intending consumer is shown. In FIG. 5C, the “Product Pick List” is in the form of a drop-down menu 51.

For the purpose of illustration in this description, an example of a product sub-type could be “beer”, taken from a “Liquor Pick List” having for example, “beer”, “wine” and “spirits”.

The process of refining the required product type continues for as many levels of product types as are determined by the central administrator. For example there may not be any further sub-types for the “beer” product type, but the “spirits” product type may lead to a “Spirit Pick List” having for example, “gin”, “scotch whisky” and “vodka”. An example of a display screen which is presented to the intending consumer in this step is shown in FIG. 5F.

In sub-step 31d, the selection of the required product type from the intended consumer is completed.

In step 32, the intending consumer is prompted to make one or more selections from a set of “Product Attribute Pick Lists”, which are generated (to be later described) by the system. Referring to FIGS. 5B, 5D and SF, examples of various display screens which could be presented to the intending consumer in this step are shown. In FIG. 5B, each attribute selection can be made with the use of a corresponding drop down menu 52a-52f. Similarly, in FIG. 5D, each attribute selection can be made with the use of a corresponding drop down menu 53a-53f. Similarly, in FIG. 5F, each attribute selection can be made with the use of a corresponding drop down menu 54a-54f.

Some of the available product attributes are common to a number of related product types and are therefore considered to be “Generic Attributes” to those particular product types. Other product attributes are only common to a specific product type. Required values for one or more of these attributes can be selected for use as search criteria. One or more of these attributes can also be selected for display in the results of a subsequent search.

For example, one generic attribute associated with the product type of liquor could be “container type” which provides preference options such as cans, large bottles, small bottles (“stubbies”) and the like. Another attribute associated with the product type of beer could be “alcohol content” which provides preference options such as high alcohol content or low alcohol content. Yet still another attribute could be “manufacturer” which provides preference options such as various of the different manufacturers of beer.

For each product, some of the available attributes are classified as “key” attributes, and others are classified as “non-key” attributes. Although “key” attributes are those that are required to uniquely identify a particular product, the user can select any combination of “key” and “non-key” attributes. No attributes are essential to be specified by the user for the system 20 to operate, but a query with no specified attributes would return a full list of products of a particular type.

In step 33, the search criteria is completed and is entered as such by the intending consumer on the keyboard 15. Referring to FIG. 5G, an examples of a display screen which could be presented to the intending consumer in this step is shown. In FIG. 5G, the selection of either the “Locate Retailer” button 56 or the “Get Result” button 57 completes this step. This search criteria information is then stored in the user interface memory area 19.

In step 34, the intending consumer is prompted by the PC 1 to enter information regarding geographical location. Referring to FIG. 5H, an example of a display screen which is presented to the intending consumer is shown. In FIG. 5H, a reference suburb is entered by the user at field 80. This could be a current, or reference physical address, for example, “5 Smith Street, Smithville”. In the example of FIG. 5H, a reference suburb is entered by the user at field 80. The intending consumer is then also prompted to enter a radius corresponding to a maximum distance that they would be prepared to physically travel in order to purchase the commodity product of interest. In the example of FIG. 5H, a radius is entered by the user at field 81.

In step 35, the search program 7 on the applications server 63 is executed. In the example of FIG. 5H, this is executed upon the user selecting button 82.

The search program 7 calls the geographical data conversion program 13 which converts the physical address data entered at step 34 relating to the consumer's geographical location to latitude and longitude. The geographical data conversion program 13, for this example, is a commercially available program entitled “GeoLoc” which is supplied by MapInfo Australia Pty Limited.

The search program 7 then calls the database retrieval program 8a of the database 8 is carried out by a searching application for example Access(™) or Oracle(™), to determine a list of records various types (to be later described) that fulfil the intending consumer's search criteria. Referring to FIG. 5J, an example of a display screen which is presented to the intending consumer is shown. In FIG. 5J, such results are listed in box 91. Hyperlinks 92 are also provided which, once selected can cause a display such as that shown in FIG. 5K. The search program 7 also calls the specialised spatial searching application 13a, such as MapInfo(™).

The search program 7 returns a dynamic document having records from the database 8 that match all of the search criteria, including the physical address data, back to the web server 61.

Referring to FIG. 5K, an example of a display screen which is presented to the intending consumer is shown. In FIG. 5K, a hyperlink 93 can be selected which then returns a map as shown in FIG. 5L.

In step 36, the search program 7 causes a display on the monitor 14 of the PC 1 in two sections; as follows:

(i) Search Summary: This is a summary of the product related inputs specified by the user and is constructed by concatenating the values (ie specific preferences) of each product attribute that were specified in the search criteria, and

(ii) Results List: This is a list of database records constructed by concatenating the values of the product attributes that were not specified in the search criteria. Hence, if no attributes were specified, then a full list of database records of products of the selected type would be returned in the Results List. The more detailed the Search Summary, the less detail provided in the Results List, and the less number of products in the Results List. The Results Lists can identify a unique product or a class of products. The fields displayed in the results list may also be specified by the user.

The ranking of each of the database records in the Results List can be controlled by the user selecting an attribute and then specifying ascending or descending order.

In step 37, the system 20 logs the result of the executed search program 7. Although step 37 is not directly related to providing information to assist intending consumers with their purchasing decisions, it is relevant to the overall operation of the system 20, since it provides the information necessary for generating revenue for the system administrator by selling advertising space on the system 20.

In step 38, the intending consumer is prompted as to whether they desire to refine the Search Summary and therefore, refine the Results Lists. If “yes” is entered into the PC 1, then step 35 is returned to. However, if “no” is entered into the PC 1, then step 39 is proceeded to. This feature of step 38 allows the intending consumer to interactively adjust the search criteria in order to identify the desired product or class of products.

In step 39, the intending consumer is provided with an option to print out the final result on the printer 11 and the method is then completed at step 40.

The execution of the user interface program 12 as described includes not only the preceding method steps but also the presentation of advertisements to the intending consumer at appropriate points.

The advertising can take the form of banner advertising, the display of which can be dependent on the type of product/service in the search request, or can be dependent on the values specified in the input search summary.

Similarly, the advertising can take the form of appropriate hyperlinks to other websites, such as those belonging to a particular retailer or supplier/manufacturer or to additional information on a particular product in the form of video clips or other multi-media attributes.

The system 20 is provided and maintained by the central administrator who has made contact with a selection of retailers or supplier/manufacturers with a participation proposal. Such a proposal can include either participation by advertising of their products/services on the system 20, or participation by having their products/services listed on the database 8.

A retailer or supplier/manufacturer can also be persuaded to advertise on the system 20 by virtue of its usefulness to intending consumers, which in turn leads to potential exposure to advertisements whilst the intending consumer is using the system 20.

The advertisements are stored in the user interface memory area 19 of the applications server 63 are retrieved with the execution of the user interface program 12 where appropriate, in return for payment from the retailer or supplier/manufacturer.

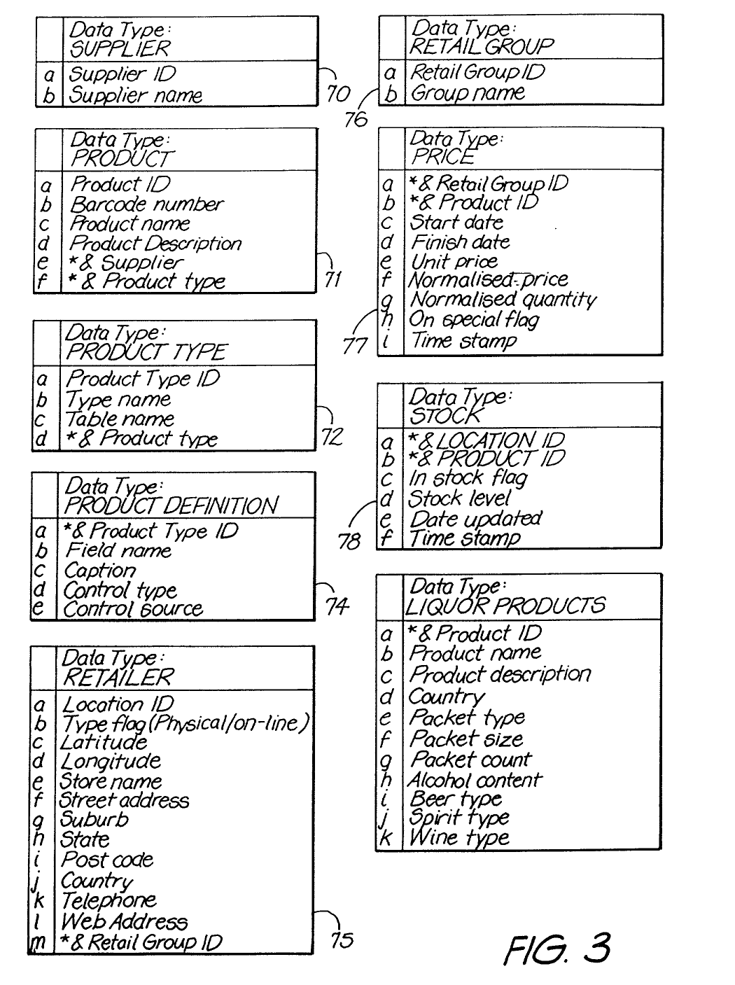

Referring now to FIG. 3, the database 8 on the applications server 63 includes a compilation of records, as follows:

(I) A table of records of the Supplier data type 70, each record of this type having fields for at least:

(a) a unique supplier identifier code (ID) for a particular one of a group of suppliers/manufacturers that have a product or products selected for inclusion in the database 8 by the central administrator; and

(b) a supplier's name corresponding to the unique supplier identifier code mentioned above in (a).

(II) A table of records of the Product data type 71, each record of this type having fields for at least:

(a) a unique product identifier code (ID) for a particular commodity product that has been selected for inclusion in the database 8 by the central administrator;

(b) a barcode number, which can be used if the particular commodity product mentioned above in (a) has a barcode number;

(c) a product name, which may not be unique

(d) a brief product description, which may be used to differentiate products with the same name but which may, for example, be packaged differently

(e) a pointer to a record of the data type Supplier; and

(f) a pointer to a record of the data type Product Type.

(I) A table of records of the Product Type data type 72, each record of this type having fields for at least:

(a) a unique product type identifier code (ID) for a particular set of similar products that have been selected for inclusion on the database 8 by the central administrator;

(b) a descriptive name for the product type; and

(c) the name of a table within the database 8 used to store the attribute information related to products that can be classified within the product type related to this particular record.

(d) a pointer to a record of the data type Product Type.

(IV) A table of records of the Product Definition data type 74, each record of this type having fields for at least:

(a) a pointer to a record of the data type Product Type that identifies the product type that an attribute description in this record relates to;

(b) the field name that this record relates to;

(c) a caption to be used when constructing forms that include the field that this record relates to;

(d) a control type to be used when constructing forms that include the field that this record relates to; and

(e) a control source to be used when constructing forms that include the field that this record relates to.

(V) A table of records of the Retailer data type 75, each record of this type having fields for at least:

(a) a unique location identifier code (ID) for a particular retail store that has entered into a participation agreement with the central administrator of the system 20;

(b) a flag to indicate if the retailer is a physical or an on-line retailer;

(c)-(d) the geographical location (if applicable) of the retail store in a latitude and longitude format;

(e)-(l) other details related to the particular retail store, for example street address, website URL, hours of opening, payment methods, and the like;

(m) a pointer to a record of the type Retail Group that is used to determine the price scale;

(VI) A table of records of the Retail Group data type 76, each record of this type having fields for at least:

(a) a unique retail group identifier code (ID) for a group of retailers that have entered into a participation agreement with the central administrator of the system 20; and

(b) retail group name.

(VII) A table of records of the Price data type 77, each record of this data type having fields for at least:

(a) a pointer to a record of the data type Retail Group;

(b) a pointer to a record of the data type Product;

(c) a start date field;

(d) a finish date field;

(e) a unit price field;

(f) a normalised price field;

(g) a normalised quantity field;

(h) an “on-special” flag field; and

(i) a time stamp field.

(VIII) A table of records of the Stock data type 78, each record of this data type having fields for at least:

(a) a pointer to a record of the type Location;

(b) a pointer to a record of the type Product;

(c) an “in stock” flag denoting availability of the particular product;

(d) a stock level code denoting availability of the particular product;

(e) a field containing the date the last update was generated; and

(f) a time stamp field.

Further data structures are provided, which are specific to each of the types chosen by the system administrator to be available.

For each product type, a table of records of a data type specific to the product type is provided. Each record of this “custom” data type is related to a uniquely identified product.

The foregoing records and their relationships to one another take into account modem commercial arrangements for the sale of some products or services. For instance, a particular Product that is manufactured or imported by a specific Supplier may be available through a chain of Retailers belonging to a Retail Group.

The foregoing records and their relationships also supports the capability of the system to provide comprehensive results, in terms of availability of a particular product, since the user is not required to know the actual stockists of the required product as would be the case for instance if a telephone directory were being used to obtain the required information.

The use of the product definitions contained within the database 8 to dynamically construct the user interface when the user interface program 12 is executed will now be described.

The system 20 queries the records in the database 8 to obtain a current list of top level product types. The results are used to populate the available options in the initial “Product Pick List” that is presented to the user in step 31.

After the user has selected an option from the initial “Product Pick List” in step 32, the system uses the selected option to query the records in the database 8 to obtain a current list of valid product sub-types related to the selected initial product type. The results are used to populate the available options in a second “Product Pick List” that is presented to the user in step 33. The process of refining the required product type continues for as many levels of product types as have been determined by the system operator. However, it is noted that only a minimum of one product pick list need be provided to provide a context for the search.

Each time the user selects an option from a “Product Pick List” the system uses the selected option to determine attribute fields (if any) that are associated with products of the specified product type. This information is then used to retrieve the corresponding field definitions from the corresponding Product Definition records.

The field definitions for the set of attributes accumulated from each level of product type are used to construct the user interface presented in step 30 to 36. This mechanism enables the system to dynamically generate the appropriate interface for the product criteria selected.

It will be appreciated that the use of the product definitions contained within the database 8 to dynamically construct the user interface, combines the flexibility of a generic search engine with the power of a product specific comparison facility. Some differences between such prior art searching systems and the present disclosure can be summarised as follows.

| | | Search Engines/ | Product Services/ |
|---|---|---|---|
| Feature | Present Disclosure | Business Directories | Supplier Sites |
| Initial Search | Initial keyword | Not applicable, since | Some systems allow |
| | search used to | all searches return a | selection from a |
| | determine context | full set of results. | preliminary set of generic |
| | for subsequent | | criteria. |
| | product specific | | |
| | search. | | |
| Product criteria | A list of fields that | A single text box is | A predetermined set of |
| | are relevant to the | provided for all | fields related to the |
| | current product type | queries, with | associated product type |
| | is generated | ‘keyword algebra’ the | are presented. |
| | dynamically. | only way to specify | |
| | | multiple criteria. | |
| Product | Relevant products | Possible web pages | Relevant products are |
| selection | are identified based | are identified based | identified based on |
| | on attribute | on keyword search. | attribute matching. |
| | matching. | | |
| Display of | Full control over the | A synopsis for each | Some systems provide a |
| results | amount of | page that was found is | coarse level of control |
| | information returned | presented. | over what is otherwise a |
| | about each product. | | rigid presentation format. |
| Product | All products | Each potentially | Some systems support |
| comparison | meeting the | relevant page must be | limited comparison |
| | requirements are | visited separately to | between products, usually |
| | displayed in a single | compare the contents | limited to only two or |
| | table, with the order | of different result | three products at a time. |
| | controlled by sorting | items. | |
| | on any field. | | |

The system 20 can also be used to select retailers (store location) using a wider range of criteria than those of the prior art. Some differences between prior art store locator technologies and the present disclosure can be summarised as follows.

| Selection | | | |
|---|---|---|---|
| criteria | Present Disclosure | Directories | Bots |
| Identify | Yes, the system can | Yes, this is the | Yes, a keyword |
| suppliers that | return a list of potential | primary basis on | search based on a |
| stock products | retailers based on the | which retailers are | particular product |
| of selected type | selection of a product | classified and | type can be initiated. |
| | type only. | presented to the user. | |
| Identify | Yes, the system can | No, although limited | Yes, a keyword |
| suppliers that | return a list of potential | keyword searching is | search based on a |
| stock products | retailers based on the | provided by some | particular brand can |
| of selected | selection of a specific | systems. | be initiated. |
| brand | brand. | | |
| Suppliers that | Yes, the system is | No, even with | Yes, this information |
| stock selected | designed to keep track of | keyword searching it | can be determined, |
| product | which retailers stock | is impossible to | but it is very difficult |
| | which products. | determine which | to actually specify a |
| | | retailers stock which | specific product using |
| | | products. | the keyword |
| | | | mechanisms |
| | | | provided. |
| Explicitly | Yes, the system is | Not really, although | No, these systems |
| identify off-line | designed to differentiate | these systems are | only work with on- |
| retailers | between on-line and | primarily for physical | line retailers. |
| | physical retailers. | retailers they also | |
| | | include on-line stores. | |
| Explicitly | Yes, the system is | Not really, although | Yes, these systems |
| identify on-line | designed to differentiate | some systems can | only work with on- |
| retailers | between on-line and | identify if a business | line retailers. |
| | physical retailers. | has a website. | |
| Apply spatial | Yes, the system uses a | Yes, but some | No, not applicable |
| filter to restrict | full spatial search and | systems can only | since these systems |
| list of retailers | the user can specify a | perform searches | only work with on- |
| | search area of any size. | using predefined areas | line retailers. |
| | | such as postcodes. | |
| Specify trading | Yes, the system | Yes, some systems | No, not applicable |
| hours | maintains details of | support details of | since on-line retailers |
| | trading hours. | trading hours. | are not subject to |
| | | | trading hours. |
| Specify | Yes, the system | Yes, some systems | No, most bots only |
| payment options | maintains details of | support details of | retrieve information |
| | payment options. | payment options. | about products. |

The system 20 of the present disclosure is very different from product search facilities of the prior art, in that it:

can handle a very wide range of products and is not restricted to a specific set of product types, and

uses attribute matching to locate relevant products and to reduce the number of results to a manageable size.

In alternative configurations, the system 20 can be used to classify a wide range of different entities, besides product types.

The system 20 provides a two-stage classification system that comprises:

hierarchical tree of categories and sub-categories for entity types, and

additional attributes for each entity type.

The system uses an ‘inheritance’ mechanism so that attributes that are common to a sub-category only need to be defined once for all entities included in the sub-tree corresponding to that sub-category.

The use of the hierarchical classification system provides a mechanism for dividing entities into mutually exclusive sub-groups. In the absence of separate entity attributes, this would provide a classification scheme that can differentiate between different groups of entities, but cannot differentiate between entities in the same group.

The use of the attribute scheme enables the system 20 to classify entities that have different properties, but which belong to the same entity group. Differentiation can be made on the basis of attributes that do not lead to the identification of mutually exclusive subgroups. It is difficult to use attribute classification without the corresponding hierarchical classification system, since it is the hierarchical classification system that divides the entities into groups that have the same sets of attributes.

The system 20 uses a ‘data dictionary’ to define an entity type. The definition includes the position in a ‘entity type hierarchy’ and the relevant attributes. The use of the data dictionary enables the system to store entity definitions in a format that can be understood by a computer program. This enables the system to dynamically control each stage of the query process, including:

generating a query screen for the user to select required attributes,

formulating and conducting the actual query, and

presenting and formatting the results

The use of the data dictionary to define entity types introduces a level of abstraction into the query system that enables it to handle a very wide range of entity types without the need for a programmer to be aware of the attributes associated with each entity.

The system 20 can be used to define and manipulate a large range of entities. Examples of the different types of entities that can be modelled using the system according to the present disclosure are presented in the table below.

| Entity | Entity type | Entity attributes | Example |
|---|---|---|---|
| Products | Product type | Product attributes | Cars have attributes like engine |
| | | | size, colour and top speed. |
| Organisations | Work type | Specialities | Lawyers may specialise in tax or |
| | | | conveyancing. |
| People | Vocation | Skill set | Programmers may be skilled in a |
| | | | variety of programming |
| | | | languages. |
| Documents | Subject | Topics | History books may include a |
| | | | discourse on Greek or Roman |
| | | | times. |
| Media | Subject | Topics | Business news may be about tax |
| | | | reform or the latest share price |
| | | | details. |

The system 20 can store information about any group of entities that can be described using an entity type hierarchy that divides entities into groups of entities with common attributes. Once the entities have been defined within the data dictionary, they can be manipulated using the dynamically generated interface.

The maintenance and updating of the database 8 will now be described. Each retailer that wishes to participate is required to provide, for example, pricing and stock details for each listed product. Each listed product must match with a listed record of the type Product 70, which includes the unique product identifier code, the product barcode (if allocated), a Supplier code, and a corresponding Product Type. The product type identifies the corresponding records in the Product Definition and identify the table containing the relevant product attributes, for example Liquor Products. Retailers who have records on the database 8 can supply updated information for their pricing and stock levels, based on either the unique product identifier or barcode identification.

The information on pricing and stock can be provided from the retailer to the central administrator in several ways. One way is in paper form, where the retailer fills in a pro-forma document provided by the central administrator. Alternatively, where computerised facilities are available the retailer can transfer the information electronically. The central administrator can then perform the required data entry into the database 8 with the aid of computerised input. For retailers having such computerised facilities, they will have their own database containing product/price information, together with utilities for querying the database and for exporting the necessary data.

The exporting of the necessary data and submission of the updated price list or stock levels can be implemented using an Internet protocol based mechanism, although a browser based system can also be used. The retailer can request the appropriate submission form by specifying a corresponding URL (Uniform Resource Location). The associated submission form then prompts the retailer for the full path for the updated price list and the file is then submitted. Optionally, the system 20 can include mechanisms such as cookies for storing the file path. Also, a dedicated client (non-browser) can be provided for submitting price lists or stock levels.

The data for exporting Price information can be arranged as follows:

A file header including retailer identification, date of creation and default settings for start and finish date if required. The start date can be specified, although a default value is applied if necessary. The finish date only needs to be specified if a definite final date is known, which could be relevant for “specials”.

Pricing records for each product, including mandatory fields related to (for instance) product identification and price, and optional fields related to (for instance) products being “on special”. The optional fields will vary from product to product.

After the retailer has submitted an updated price list as described above, the system 20 adds the new price listing to the database 8. The information contained in the updated price list is added to a temporary table in the database 8. The system uses some information from the file header to complete the fields for the database. The system also includes a date and time stamp with each record as it is added to the database. In the event of a problem with differentiating between two records the time stamp will be used to identify the most recent record.

After a new record is added to the database 8, the system 20 modifies any pre-existing records for the same retailer/product combination. These modifications can involve:

1. splitting pre-existing records that start before and finish after the new record,

2. resetting the finish date for any pre-existing records that start before the new record, and

3. resetting the start date for any pre-existing records that finish after the new record.

It should be noted that these modifications do not occur on records with finish dates that have been set prior to a new start date, or records with start dates already set to dates after the new finish date.

The new records for updated price information are copied from the temporary table and appended to the price table in the database. Records within the database are not modified in order to update prices, rather, existing records are always superseded by new records.

Finally, the system 20 removes obsolete records from the database 8. Such obsolete records are those which have finish dates that have expired, or have finish dates that are prior to this start date (logically superseded). The system 20 checks that at least one valid retailer/price entry remains and will raise a warning if no valid entries are present after this last step. Obviously, as products are discontinued these warnings will be generated but will not indicate an actual problem.

The data for exporting Stock information can be arranged as follows:

A file header including retailer identification and date of creation.

Stock records for each product, including fields related to product identification and a keyword to indicate the action to be taken. The keywords for stock operations are ‘Add’, ‘Update’, and ‘Delete’. Other fields are optional and may vary from product to product, including fields indicating products being “in stock” or “out of stock” or current stock levels. The date updated must be specified if either of these fields is supplied.

After the retailer has submitted an updated stock listing as described above, the system 20 adds the new stock listing to the database 8. The updated stock information is used to modify existing records in the stock table in the database. New records are only appended if required to indicate a new product being stocked by a retailer. Old records are deleted if required. Most housekeeping is taken care of by the update process. The exception is housekeeping related to changes in the products database, such as when a particular product is discontinued.

The foregoing computerised updating has the advantage in that the database 8 can be made “live”, so as to provide constantly updated information, which is of particular use in relation to stock levels and items that are “on special”.

Although it will generally not be necessary for retailers to export all price information for every update, if dynamic monitoring of stock levels is provided, it will be only necessary to supply a price update for a single product. Although such “incremental” updates can be implemented, a “full” update can also be completed on a regular basis.

A number of enhancements to the system described above, will now be described.

Price Normalisation:

The result returned by the search program 7 can include the calculation of a normalised price. The normalised price is determined by dividing the item price by the net quantity. This provides a method for comparing the same, or similar products, that are packaged in different size units.

Distance Factor:

The results returned by the search program 7 can include the calculation of an adjusted price based on the distance of the retail outlet from the specified origin of the search. The adjusted price may be determined using a distance factor, specified as cost per unit distance, that is supplied by the user. This provides a method for discriminating between retail outlets that are different distances from the search origin.

Cost Adjustment:

The results returned by the search program 7 can include the calculation of an adjusted price based on other associated costs or savings. The adjusted price can include allowances for additional costs such as delivery or taxes, and can be adjusted to allow for savings associated with staff or shareholder discounts or other loyalty or benefit programs. This provides a method for discriminating between different retail outlets and also facilitates comparison between on-line and off-line purchases.

Currency Conversion:

The results returned by the search program 7 can include the calculation of an adjusted price based on conversion of currencies. This provides a method for discriminating between retail outlets in different countries and further facilitates comparison between on-line purchases and off-line purchases. This feature requires that currency exchange information also be maintained.

Identification of Specials:

The association of product and price for a particular retailer may also include support for an additional attribute that can be used to indicate when the particular item is “on special”. The identification of a product as “on special” can be subject to verification before being displayed to the user, with clearly defined rules regarding specials that minimise misuse of the attribute. For example, a rule may require that the “special” price be at least a certain percentage, say 10%, less than the last used “standard” price from the same retailer. Alternative methods of calculating a “standard” price may include averaging of all prices from all retailers. A product would then be “on special” if it is 10% cheaper than the average price. These rules may be also be used to indicate any price that was a certain amount below average. In other words, the system would identify “good buys” even if the relevant retailer did not identify the item as being “on special”.

Shopping Lists:

An extension to the system (20) involves the preparation of a price comparison for a combination of products, rather than a single item. The user supplies a shopping list and the system then calculates a total price for purchasing the specified items from a number of retail outlets. This process may involve further interaction with the user in order to identify unique products for each item on the list. Whilst some items on the list may be more expensive, the user may select the retail outlet with the cheapest total price.

E-mail Notification:

The system (20) can also be enhanced to support e-mail notification of changes in product status within the database 8 to consumers. Examples of situations where can notification may be used include notification when a particular product:

goes on special;

drops below a specified price;

becomes available after being released; and

becomes available after being out of stock

Users would register the product(s) they were interested in by specifying their e-mail address and the product identifier. As the system is updated the register is checked and e-mails sent to the various users. A variation to this scheme may involve registration of a “query” that if satisfied then generates an e-mail notification. Examples where this may be of use include notification of the release of a new book by a particular author or an audio CD by a particular artist.

Stock Levels:

The association of product and price for a particular retailer may also include support for an additional attribute to indicate stock levels at particular stores. This assists consumers in identifying which retail outlet to visit. Such analysis may also be used to indicate when stock that is not currently available, is expected to become available.

Analysis:

An extension to the system (20) involves the calculation of prices that involve more sophisticated calculations based on a set of specified parameters. Examples of price comparisons involving more sophisticated analysis include:

mobile telephone plans;

long distance telephone calls carriers;

mortgage costs; and

insurance policies

These types of price comparison typically involve evaluation of specific financial models.

Product Information:

Product specific information that is additional to the attributes maintained in the database 8 can be stored, for example, video clips from advertisements, reviews of books or CD's, tasting notes for wines. Optionally, a separate search mechanism can be provided to search through this additional information.

Coupons:

The effectiveness of the system 20 in converting “queries” into “sales” can be monitored using coupons. Coupons can be used to monitor the impact of the system. Users would print out a “coupon” when they had finished their query. It may contain some details on the query performed. Presentation of the coupon at the time of purchase can then provide a discount on the final purchase price thus enticing users to further use the system 20.

Delivery Service:

In order to provide a complete on-line service to consumers it may be appropriate to provide a delivery service that works closely with the system. The delivery service can operate in specific areas and collect orders from regular retail outlets and deliver them to the household. The delivery service may be operated on a franchise basis. This may be combined with an on-line payment system and would effectively make current retailers the “distribution warehouse” for what would become an essentially on-line system.

Smart Indexing System:

The initial product type can be selected by the user with the aid of a smart indexing system, instead of step 31 as earlier discussed. Such a system incorporates a method of dynamically constructing an index that maps one word to a list of alternative words. Construction of the index is facilitated by a database that contains searchable words and their alternatives and includes a procedure for adding words to the database.

Firstly, to assist with understanding the smart indexing system, the following serves as a background explanation.

Business directories use a classification system to assist users locate the business service they require. This approach is used by most hardcopy business directories and on-line business directories. In order to locate a business the consumer must know the name of the category the business is listed under. However, there can be a number of possible problems that consumers will experience in determining the correct category, particularly when using an on-line directory.

The most common problems with both hard copy and on-line directories is that the most appropriate category for a particular business is not always obvious. For example, a legal practise may be classified under “Attorneys”, “Lawyers”, “Legal Services”, or “Solicitors” depending on the classification system.

Some directories provide an index to assist consumers to identify the most appropriate category based on a set of synonyms. Other directories, particularly on-line systems, use a hierarchy of categories through which the consumer can browse to locate the required category.

The interactive nature of on-line directories makes it possible for them to support keyword searching. This may cause problems when a keyword can relate to multiple categories. For example, the keyword “coffee” may locate categories of “Coffee beans”, “Coffee machines”, and “Coffee mugs”. Some systems would present all three categories and request a selection from the consumer. Other systems would stop at the first category that matches. The keyword matching systems are also generally intolerant of spelling errors. For example, the keyword “Optometrist” would not locate the category for “Optometrists”.

In summary, there are three types of problems that consumers may have when determining a category using existing business directories: problems associated with synonyms, problems caused by ambiguous keywords and problems caused by spelling errors. Although some systems handle some of these problems, no system appears to handle all three in a consistent manner. Furthermore, the underlying data structures are generally relatively static and require external intervention for new connections between words to be added.

The smart indexing system seeks to overcome or at least ameliorate one or more of the foregoing drawbacks.

The smart indexing system includes a database and a means for manipulating the information in the database. In one example, the smart indexing system supports a set of ‘valid’ identifiers, and a set of ‘alternate’ identifiers that are mapped to the ‘valid’ identifiers. In the case of a business directory, the valid identifiers would be the actual categories used by the directory and the alternative identifiers would be the ‘synonyms’ for these categories. However, the term ‘synonym’ in this context means not only identifiers with similar meanings, but those identifiers which are associated to the valid identifier in any manner.

The system can handle identifiers which are spelling mistakes in the same way it handles identifiers which are words of a similar meaning.

The system supports a many-to-many relationship between alternate and valid identifiers: one alternate identifier can map to multiple valid identifiers and each valid identifier can have multiple alternate identifiers.

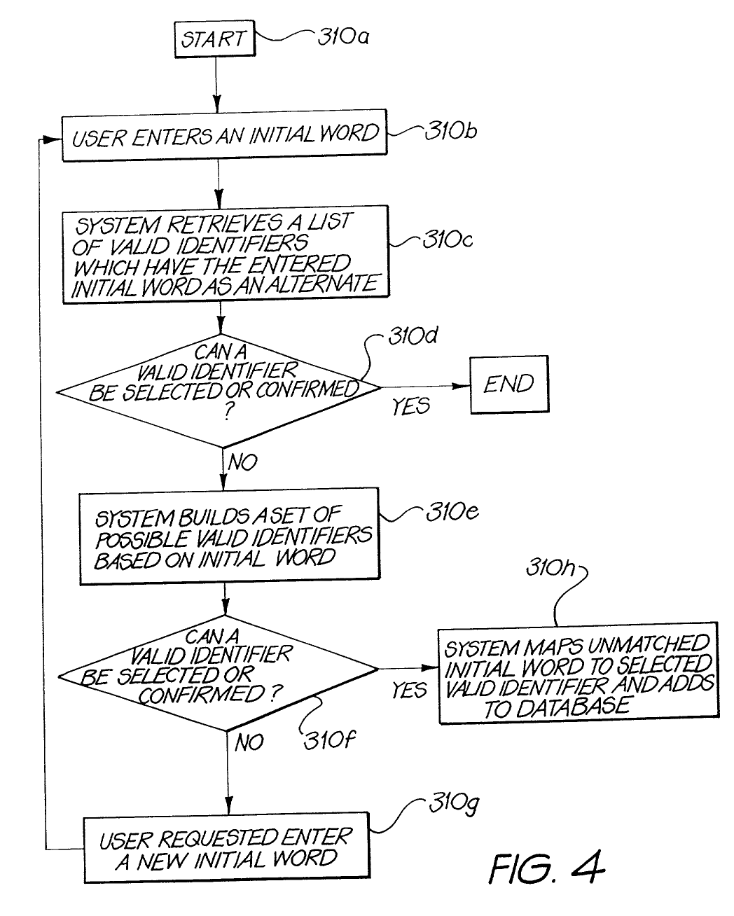

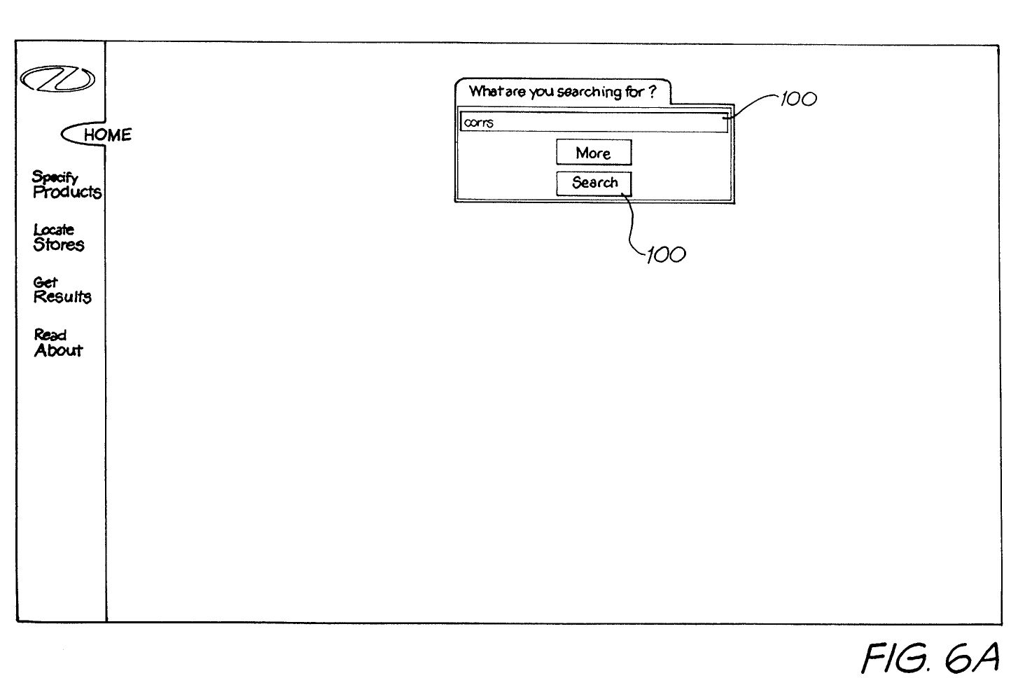

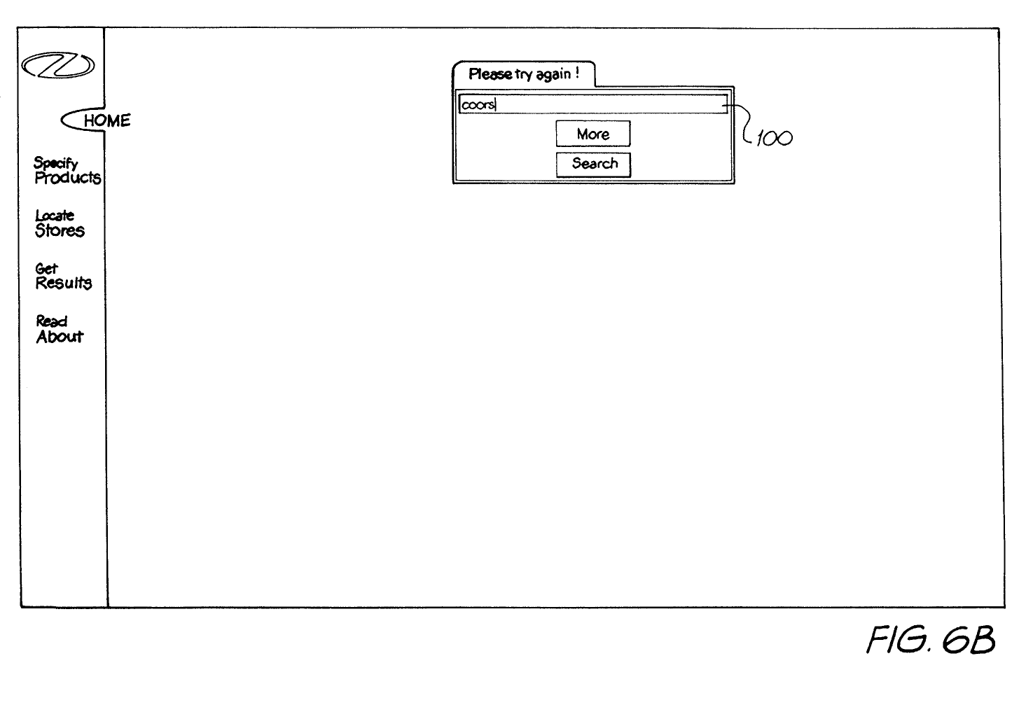

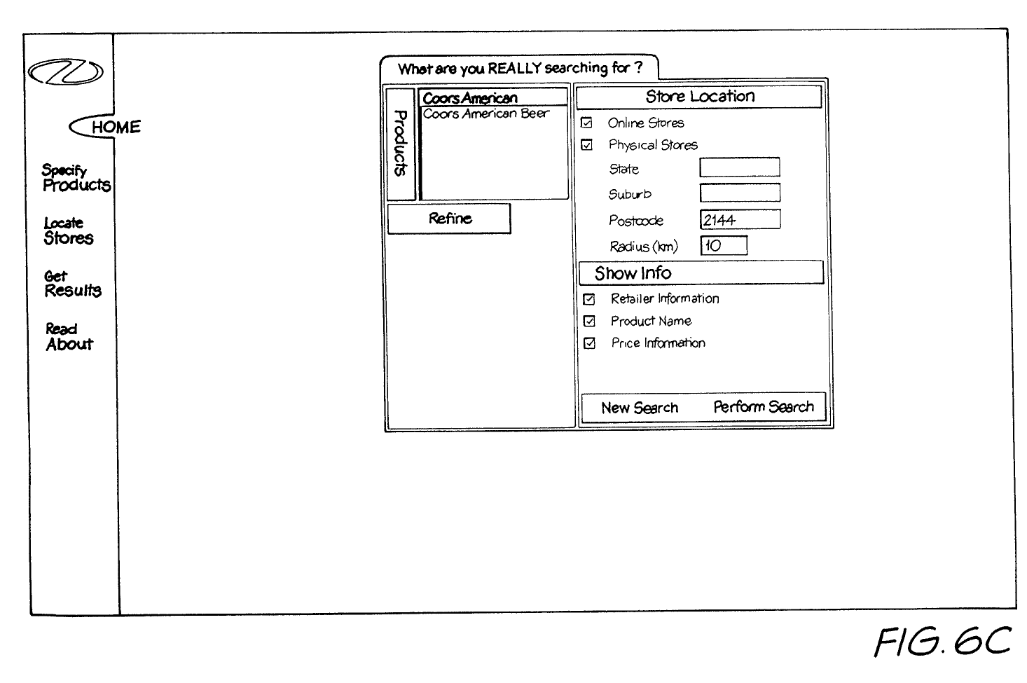

An example of the smart indexing system will now be described with reference to FIG. 4 which commences with a start step 310a. Reference is also made to the display screen representations of FIGS. 6A to 6H for this example.

In step 310b, the user is prompted to enter an initial word. Referring to FIG. 6A, an example of a display screen which is presented to the intending consumer is shown. In FIG. 6A a field 100 is provided in which the consumer can enter the desired term, in this example “corrs”.

In step 310c, the initial word that had been entered by the user is used to search a list of valid identifiers that correspond with a valid category. In FIG. 6A, the search button 101 is selected to initiate this search.

Step 310d determines whether the user's initial word can provide a valid identifier or whether the search should continue.

In step 310e which is proceeded to in the case of the latter, the initial word that had been entered by the user is used to search a list of alternate identifiers, each of which have been previously mapped as such, with one or more valid identifiers.

Step 310f determines whether the user's initial word can provide a valid identifier or whether the search should continue.

If the outcome of step 310f is that a valid identifier has been provided, then step 310h is proceeded to, wherein the system maps each of the unmatched (if any) initial words to the eventual selected valid identifier. This mapping can then be used for future searching. An example of a display screen which is presented to the intending consumer after this step is shown in FIG. 6C. The display screens presented to the consumer can then continue in a similar fashion to that described in relation to FIGS. 5J to 5L.

If the outcome of step 310f is that a valid identifier has not been provided, then step 310g is proceeded to, wherein the user is requested to enter a new initial word. This cycle repeats until a valid identifier is selected. An example of a display screen which is presented to the intending consumer during such a cycle is shown in FIG. 6B. As with FIG. 6A, a field 100 is provided in FIG. 6B, within which the user can enter the new term.

The following pseudocode describes the selection of a valid identifier from a given initial word:

While valid identifier not confirmed

User requested to specify initial word

Current initial word added to a list of unmatched words

System retrieves list of valid identifiers which have initial word as an alternate

If list contains at least one entry then

User requested to select/confirm required valid identifier

Else

While valid identifier is not found

System builds set of possible valid identifiers based on initial word

System adds set of possible valid identifiers to database

If set contains at least one entry

User requested to select/confirm required valid identifier

End If

Wend

End If

Wend

For all entries in list of unmatched words

Map unmatched word to selected valid identifier

If pair not already in database then add as new entry to database

Increase use count for pair of identifiers

Next

System returns selected valid identifier

An advantage of the smart indexing system is that the mapping from alternate identifiers to valid identifiers occurs dynamically in response to the user's specified word.

There are two distinct mechanisms involved in generating new mappings:

1) System builds mapping based on the set of valid identifiers and some specific production rules

2) System generates a mapping based on the list of unmatched words and the final valid identifier

There are a number of production rules that can be used to build a list of possible valid identifiers from a given word. The simplest of these is to use string matching to find valid identifiers that contain the supplied word as a substring. For example, in a business directory system the word “Beer” may return a set of possible valid identifiers corresponding to the categories “Beer brewing equipment”, “Packaged beer”, and “Wholesale beer supplies”. All of the resulting valid identifiers would be added to the database and would therefore be available to the next person who submits the same initial word. More sophisticated production rules could include using knowledge of category hierarchies to retrieve not only a valid identifier but the set of valid identifiers corresponding to the related sub-categories as well. For example, the initial word “Liquor” may return “Beer”, “Wine” and “Spirits” in addition to the actual category of “Liquor”. This enables the user to refine their search as part of the process of selecting the required category. Even more sophisticated production rules could involve the use of an external thesaurus or spelling checker to assist with identifying relevant valid identifiers.

The mechanism for mapping unmatched words to the valid identifier that is eventually selected is intended to act as a user oriented synonym generator and spell checker. It assumes that the unmatched words are somehow related to the eventual selection and that the user is able to come up with alternatives when their previous attempts at specifying a valid identifier have been unsuccessful. An example of this approach would be a user that accidentally typed “Optomitrist” instead of “Optometrist”, when the system fails to find a match the user may realise their mistake and correct it. The system would then add “Optomitrist” as an alternative for “Optometrist” in the database, so that the next user that makes the same mistake would automatically be presented with the correct identifier as an option. Similarly, a user who was unsuccessful with “Glazier” may try “Window” and have more success.

Refinements to the smart indexing system will now be discussed. The basic system assumes that the list of valid identifiers are from a single set, such as the set of category names in a business directory. The system can be extended to support sets of keywords from multiple sources or contexts. For example, many business directories allow users to search for a category or a business name. In the revised form of the SIM these two sets of valid identifiers (the set of categories and the set of business names) can be combined, with an additional type flag to indicate the context to which an identifier belongs. The production rules used to build a list of potential identifiers for a given word can be different for each context. For example, the build from the category context can make use of the category hierarchy, but the build from the business name context would only use string matching. There is no theoretical limit on the number of contexts of identifiers that can be combined.

Another refinement that can be made to the system is the inclusion of counters in the database. Each time an alternate-valid identifier combination was used the use count for that combination would be incremented. When the list of possible identifiers was built the counters would be initialised to zero. As the different combinations were selected the use counts would increase. The inclusion of counters allows the combinations to be weighted, so that the list of possible identifiers presented to the user can be ordered.

Another refinement that can be made to the user interface is the ability for a user to select ‘advanced options’ as part of their search. These advanced options may include the ability for the user to specify the context in which the supplied word is to be considered. This may be used to improve the response time of a search or to reduce the number of alternatives that are presented.

Other advanced search options can include the ability to use the supplied keyword to search in other contexts that are not included in the set of contexts automatically handled by the mechanism. For example, in a business directory situation a user may specify that the system undertake a full database search using the keyword rather than restricting the search to the category or business name contexts, even though such a search may take a significant amount of time.

The smart indexing system actively generates new mappings in response to the keywords submitted by the users. In some situations the mechanism may generate inappropriate synonyms for some of the valid identifiers. Maintenance of the system could therefore involve the periodic review of the database and removal of any serious discrepancies. As part of the review process it may also be appropriate to check for deliberate manipulation of the system, such as the introduction of inappropriate alternatives or manipulation of counts for commercial advantage.

In summary, features and/or advantages of the smart indexing system include the following:

Dynamic generation of mapping between user submitted words and potential valid identifiers,

Handling of a variety of relationships between words, including synonyms and spelling variations.

Effective mechanism for resolving ambiguous user submitted words by presentation of list of likely alternatives for valid identifiers.

Capability for refining a query as part of the confirmation process.

Ability to generate lists of valid identifiers from a variety of contexts and to handle them in a consistent manner without requiring the user to specify the context of their search.

Ability to incorporate different production rules for each context.

Ability to incorporate use counters to assist with ranking of likely valid identifiers.

Context Based SMS Directory Facility:

SMS (Short Messaging Service) is a service supported by the GSM (Global System for Mobile) standards, used for cellular telephone systems. SMS enables users to send or receive text messages of up to 160 characters, using a hand held mobile device such as a mobile digital telephone handset or a Personal Digital Assistant (PDA).

For example, to send a message using a mobile telephone handset the user enters or types each character of the message into the keypad. The message is then sent to a particular telephone number having an SMS capability via an SMS Message Centre in the GSM cellular network.

The user can also receive SMS messages on a display window of the mobile telephone handset. Such messages can originate from another SMS capable telephone, or from a computer connected to the SMS Message Centre.

There is disclosed a Context Based SMS Directory Facility which supports context-specific queries on a database holding records of information related to marketable entities. Access to the database is provided by way of a wireless device and more particularly, a wireless device that can communicate using SMS protocol. Such context-specific queries can include for example, those that are location-specific, user-specific and/or time-specific.

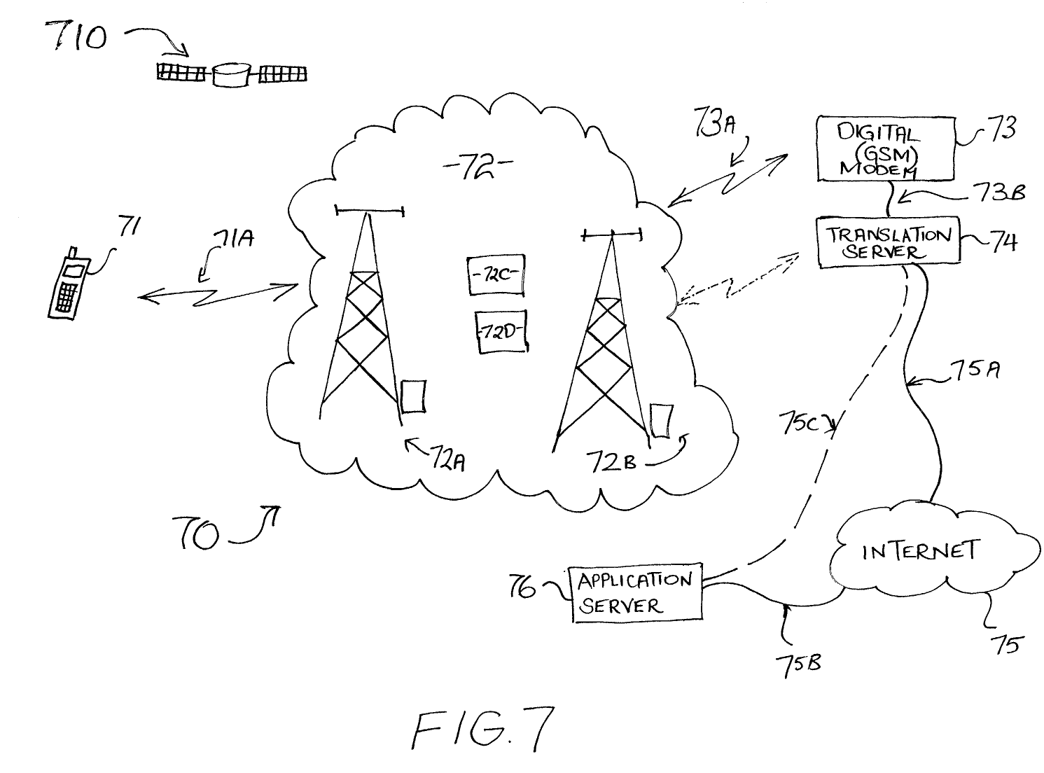

Firstly, the infrastructure required to implement the Context Based SMS Directory Facility will be described. FIG. 7 shows a system 70 for implementing the Context Based SMS Directory Facility and includes a mobile telephone handset 71, a GSM Cellular Network 72, a Digital (GSM) Modem 73, a Translation Server 74, a computer network 75 which in this case is the Internet, and an Application Server 76. A GPS satellite 710 is used in an alternative configuration (later described).

The GSM network 72 includes a plurality of Base Stations 72a, 72b, a Mobile Telephone Switching Centre (MTSC) 72c and an SMS Message Centre 72d. Each one of the Base Stations 72a, 72b covers a geographical area (cell), inside of which mobile cellular telephone handsets such as the handset 71 can communicate over wireless path/s 71a.

Each one of the Base Stations 72a, 72b rebroadcasts incoming transmissions originating from the mobile telephone handset 71, to the MTSC 72c, at a higher power over microwave or optical fibre dedicated data links (not shown).

The GSM Network 72 in turn, communicates over link 73a with the Digital (GSM) Modem 73 which converts signals that have been transmitted at a particular frequency through one medium, to a higher or lower frequency for transmission through another medium.

The Translation Server 74 communicates with the GSM Modem 73 over link 73b and converts SMS messages derived from the network 70 to HTTP (in HTML), and HTTP (in HTML) messages to SMS, for return to the network 70.

The Application Server 76 communicates over links 75a and 75b with the Translation Server 74. The Application Server 76 contains a search program and a business directory database, which is similar in function to that installed on the host computer 60, and as described earlier in relation to the Product Information Distribution System.

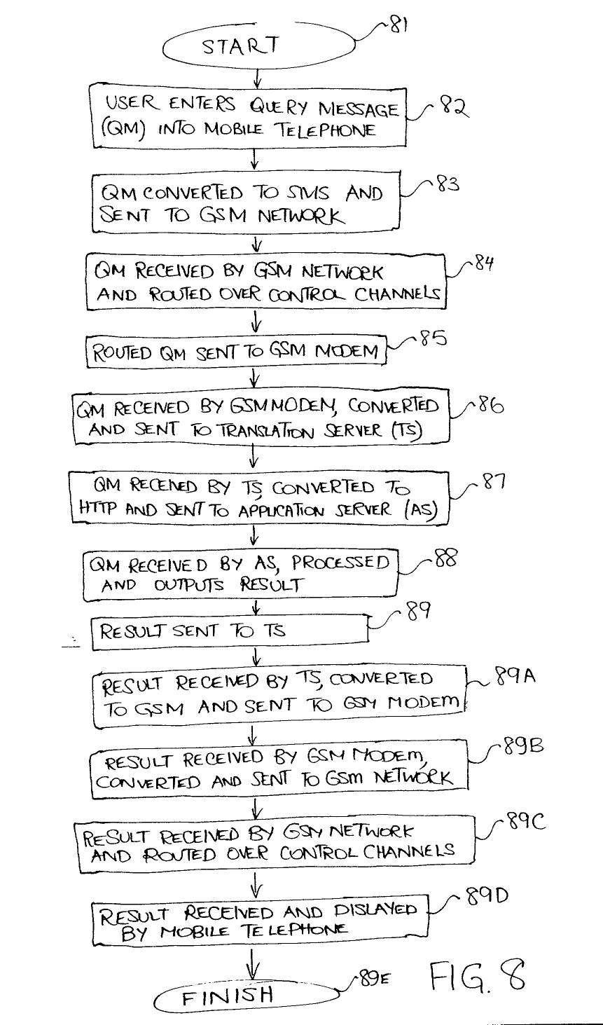

An exemplary method 80 according to the Context Based SMS Directory Facility, incorporating the infrastructure of FIG. 7, will now be described with reference to FIG. 8.

A start step 81 commences the method 80, after which step 82 is proceeded to.

At step 82, a user enters a query message, being a string of characters constituting a text message of up to 160 characters, into a mobile telephone handset 71 via the keypad.

Next at step 83, the query message is converted into SMS format and transmitted by the handset 71 to the GSM Network 72.

The SMS formatted query message includes the text message, plus a time stamp and the originating telephone number corresponding to the handset 71. Additionally, and at some time before reaching its final destination at the Application Server 76 (later described), the query message is provided (or “adjusted”) with context information (or “parameters”).

Passing next to step 84, the SMS query message is received by the GSM network 72 and routed over the control channels of the GSM network 72 via the SMS Message Centre 72d.

At step 85, the routed SMS query message is sent to the GSM Modem 73.

Next, at step 86, the SMS query message is received by the GSM modem 73, converted to a frequency and/or format suitable for re-transmission and sent to the Translation Server 74.

At step 87, the query message is received by the Translation server 74, converted to HTTP (Hyper text transfer protocol), and sent to the Application Server 76.

Continuing at step 88, the HTTP query message is received by the Application Server 76 and processed by the execution of the query upon the business directory database. This step is similar to step 35 as described earlier in relation to FIG. 2, whereby the search program 7 on the applications server 63 is executed. The server 76 thereby forms a query result which at step 89, is returned from the Application Server 76, and sent in HTTP format to the Translation Server 74. The query results, as well as including the response of the server 76 to the query, also includes the originating telephone number.

At step 89A which follows, the query result is received by the Translation server 76, converted from HTML to SMS format, and sent to GSM modem 73.

At step 89B, the query result is received by the GSM modem 73, converted to a frequency suitable for re-transmission and sent to the GSM network 72.

At step 89C, the query result is received by the GSM network 72 and routed in a similar fashion to that described earlier in relation to step 84.

Next at step 89D, the routed SMS query result is sent to the originating mobile telephone handset 71 which then displays the query result as a text message.

Finally, step 89E completes the method 80.

As referred to in step 83, the context adjustment of the initial query message can be made at various points in the entire transmission path between the creation of the initial query message at step 82, and the final query message that is used to query the database at step 88.

More specifically, the context information can be added at any one or more of the following points of the transmission path.

1. mobile device 71,

2. GSM Network 72,

3. Translation Server 74,

4. Application Server 76.

The implementation of the above possibilities for context adjustment will be understood from the following specific examples that can be provided for querying the business directory database.

Location-specific Context:

Here, the geographical location of the mobile telephone handset 71 is provided as an implicit parameter within the query message.

For example, information can be requested by the user of the mobile telephone handset 71, which relates to the closest geographical location of services such as an automatic teller machine (ATM), petrol station, post box, food outlet, or pharmacy, to name but a few.

Also, the results of a request can be limited by the user's location. For example, if a user in Australia types in a location for a suburb in Australia, then the results will be limited to Australian suburbs.

The geographical location of the mobile telephone handset 71 can be determined in a number of ways.

Firstly, the user can manually include a specific geographical location into the original, query text message.

Alternatively, the location of the handset 71 can be determined with reference to the location of base stations 72a, 72b of the GSM Network 72. At any time, the mobile telephone handset 71 could be receiving a signal from up to five base stations, although only one of the base stations is actually being used. This provides the ability to derive an approximate location, based on the primary base station being used by the mobile telephone handset 71.

A more refined determination of the location of the handset 71 is based on the relative location of all base station signal towers and can include consideration of the comparative signal strength or signal timing.

Further, the use of satellite positioning systems such as the Global Positioning System (GPS) 710 can be used to determine the geographical location of the handset 71. This requires special hardware and/or software to be incorporated into the handset 71 such as a GPS receiver chip and requires modifications to the Subscriber Identity Module (SIM) card.

Generally speaking however, the ability to automatically determine the user's physical location through their mobile telephone handset 71 requires the support of the mobile telephone companies who own and/or administer the GSM Network 72.

User-specific Context:

Here, one or more details from a stored profile related to a specific user is automatically incorporated into the parameters of each query message originating from that user.

Such a profile can be stored at either the Translation Server 74 or the Application Server 76. The need to reference a stored profile can be identified for instance, by the originating phone number from which the query is made.

Each stored profile can include for example, information such as the user's home address and preferred bank. Therefore, a search can be performed on the area between a current geographical location and their home to find the relevant market entities in between. Alternatively, if the user sends a request for the nearest ATM, the search can be limited to ATM's that belong to their bank, as identified in their profile.

Time-specific Context:

Here, information is requested relating to businesses or services that are open or otherwise available at a specific time of day, for instance at the time the query message is created. For example, the results of a query can be limited to those businesses which are open at the time the query is made. This is particularly useful for late night or weekend inquiries.

Implicit Commands:

An enhancement can be provided such that a command, rather than a parameter is modified by the context of the query message. For example, messages sent to a particular telephone number can be identified as a search request for a particular service. Such telephone dedicated numbers can be associated with specific services (such as the ATM's for a particular bank), or a category of services (such as ATM's in general).

Referring back to FIG. 7, an alternative arrangement shown in phantom, provides a direct connection 75c between the GSM network 72 and the Translation Server 74. This arrangement enables search results to be sent to the mobile telephone handset 71 faster and easier and avoids queuing of messages on the GSM Network 72. However, cooperation of the mobile phone carriers is required.

The SMS messages are passed directly from the GSM Network 72 to the Translation Server 74. This saves the additional step of sending each SMS message from the GSM network to the GSM modem 73 and then to the Translation Server 74. This arrangement can work both ways so that the search result is sent directly from the Application Server 76 to the Translation Server 74 and then directly onto the GSM network 72 and to the mobile telephone handset 71.

Further, this arrangement allows for further interception of SMS messages at the Translation Server 74 or the Application Server 76.

The difference in processing the query messages is summarised in the table below.

| | With direct |
|---|---|
| Without direct network connection | network connection |
| User types SMS message | User types SMS message |
| Sent from mobile telephone | Sent from mobile telephone |
| Received by GSM network | Received by GSM network |
| Routed by GSM network as a standard SMS | Identified as a location |
| | based enquiry |
| Sent to GSM modem | |
| Passed to Translation Server | Passed to Translation |
| | Server |
| Converted from SMS to HTTP (HTML) | Converted from SMS to |
| | HTTP (HTML) |
| Forwarded to Web Server | Forwarded to Web Server |
| Processed by Application Server | Processed by Application |
| | Server |
| Reply sent back to Translation Server | Reply sent back to Trans- |
| | lation Server |
| Converted from HTTP (HTML) to SMS | Converted from HTTP |
| | (HTML) to SMS |
| Passed to GSM modem | |
| Sent to GSM network | Sent to GSM network |
| Routed by GSM network | Routed by GSM network |
| Sent to mobile telephone | Sent to mobile telephone |

Abbreviated Command Line Interface:

The host computer 60 of FIG. 1 can be accessed using a wireless, substantially non-graphical device, such as a mobile telephone handset. Similarly, the Context Based Directory Facility as described in relation to FIG. 8 can be accessed. These forms of wireless communication can be facilitated with the use of an Abbreviated Command Line Interface (CLI).

Before describing the Abbreviated CLI in detail, the following is provided by way of background discussion.

Command Line Interface (CLI) generally refers to an early method for enabling a user to interact with a computer system. Examples of CLI's include DOS and Unix, but CLI methods of interaction have been used for a full range of computer systems. A key feature of CLI is that it accepts text only and requires the user to know a set of specific, correct commands.

In 1984, the Apple Macintosh became the first commercially available computer to use a graphical user interface (GUI). Since then, the GUI has become the standard method for users to interact with computers. GUI's are primarily menu driven and require little or no advanced knowledge from the user. The Windows(™) operating system manufactured by Microsoft Corp. of the U.S.A. is an example of a GUI.

The network now called the Internet began in 1969 when, for the first time, two computers were connected to create the ARPANET. In 1989, the publishing of the definitions for the Hypertext Markup Language (HTML) and the Hypertext Transfer Protocol (HTTP) facilitated the creation of the World Wide Web (WWW). In 1993, the Mosaic browser enabled users to access the WWW using a true ‘point and click’ GUI. The Internet and WWW have grown dramatically since then and today users with no prior computer experience are able to access information on the WWW with a minimum of training.

The development of mobile telephones, personal digital assistants (PDA) and corresponding wireless networks has led to increasing interest in wireless information services. Many of the information services identified for delivery over wireless networks are based on content currently accessible on the WWW. However, there can be difficulties converting content that is developed for the WWW into a format suitable for a hand held device.

Some hand held devices use the Palm(™) or Windows(™) CE (Microsoft Corp.) operating systems, but there is already a significant amount of information available based on the use of the Wireless Application Protocol (WAP). A limited range of services are also available based on the Short Message Service (SMS), in which the text of messages sent or received wraps to fit the screen and the user scrolls the message across or down the screen to read it.

However, data entry using a mobile telephone is often quite difficult because each character needs to be typed using the standard telephone key pad, with each key typically allocated three or more alphanumeric characters. The number of keystrokes required to enter a request can therefore be quite high. There are also some characters that are difficult to type (such as “,” and “/”) and some of the characters found on a conventional keyboard (including ˆ , { }, [ ], \, ˜, ') are not available at all.

Further, users of SMS services are generally charged on a per-message basis. Therefore, it is undesirable from a user's point of view, to send multiple messages to clarify a request. Ideally, a single request should return the required results, with no need for clarification.

As earlier mentioned, any message sent using SMS is limited to 160 characters which means that the use of the message space is often required to be optimised. Such message space applies to both the user's request, which should be abbreviated for ease of typing and best use of the message space, and also to the reply containing the results, which should be configured to fit as much information as possible into the message.

Existing, computerised spell checkers and thesaurus facilities generally use prepared abbreviations to match relevant words. Such facilities often generate appropriate abbreviations by using standard abbreviation rules, which include removing spaces, vowels and double characters.

Other systems use macros or an autotext function which associate particular abbreviations with words or phrases so that the user types the abbreviation then selects the appropriate command to get the expanded text.

Some systems use an autocomplete function to offer expanded words while the user is typing. Such a function works by comparing letters typed by the user to a list of possible matches and suggesting complete words to the user. This type of system requires confirmation from the user that the suggested word is correct.

The basic structure of a CLI is a single line of text that includes a command, zero or more parameters, and possibly a set of command switches that instruct the computer on how to interpret the command. This can be represented as:

Command [Parameter1 [Parameter2 [Other parameters]]] [Switches]

where:

the tokens delimited by “[“and“]” are optional tokens that can be included in the command line.

For example, a location based business directory service such as that earlier described in this specification, could use a command line such as:

FINDNEAREST PETROL TURRAMURRA NA

where:

‘FINDNEAREST’ is a valid command that identifies a particular search,

‘PETROL’ is the type of product or service required, which is the first parameter required by the ‘FINDNEAREST’ command,

‘TURRAMURRA’ is a suburb for which the search is required, which is the second parameter required by the ‘FINDNEAREST’ command, and

‘NA’ is a switch to identify the actual information required in the results, which in this example could indicate that (N)ame and street (A)ddress are all that is required from a set of options that also include (T)own, (P)hone, (F)ax, and (D)istance.

An example of a method according to the Abbreviated CLI will now be described.

The Abbreviated CLI minimises the amount of data entry required for each user request and optimises the use of available message space. A combination of generation and translation techniques related to abbreviations is used to provide a solution that:

1. uses rules for determining acceptable abbreviations dynamically, and

2. applies these techniques to commands and parameters.

In order to generate a valid request, which could be applied to the system 20, as earlier described for example in relation to FIG. 1, a user only needs to enter an abbreviation that contains sufficient letters for a match to be generated from a finite set of alternatives. The abbreviations may be used for any part of the command line command, parameters or switches, so the entire request can be entered with a minimum number of letters.

The user can choose to abbreviate a word using any set of letters, provided those letters are in the correct order. The Abbreviated CLI considers each letter provided and dynamically determines possible matches on the basis of the order of the letters, until the required keyword is identified. The Abbreviated CLI is not reliant on a static lookup of acceptable abbreviations. The only requirement is that the number of letters provided is sufficient for the system to differentiate the required keyword from all other alternatives.

In the example given above, the use of abbreviations as described would make it possible for the request to be shortened to:

FN PTRL TMURA NA

provided that there were no other valid commands with “F” and “N”, no other products with “P”, “T”, “R” and “L” and no other suburbs with “T”, “M”, “U”, “R” and “A”.

In a rule based system, the actual abbreviations used can vary provided that only a single valid command or parameter is identified.

In effect, the Abbreviated CLI accepts abbreviations for any part of the command message, provided the abbreviation (token) uniquely identifies a valid keyword. Each supplied abbreviation of a token is checked against a list of valid keywords for the context in which the token is used.

The basic algorithm for the Abbreviated CLI can be represented by the following pseudocode:

For each Entry in AllValidKeywords

PossibleValuesList.Partial=AllValidKeywords.Value

PossibleValuesList.Full=AllValidKeywords.Value

Next

Total=Length(strlnput)

For l=1 to Total

StrX=Mid(strlnput,l,1)

For each Entry in PossibleValuesList

If InStr(StrX, PossibleValuesList.Partial)>1 Then

NewList.Partial=Mid(PossibleValuesList. Partial,2)

NewList.Full=PossibleValuesList.Full

End If

If NewList is Empty then

Exit—no match

Else if NewList has only one entry

Exit—found unique (best match but may not be correct)

Else

PossibleValuesList.Partial=NewList.Partial

PossibleValuesList.Full=NewList.Full

End If

Next

Next

If PossibleValuesList has more than one entry then

If SubstringRule applies then

Return lowest order substring

Else

Exit—ambiguous request

End if

End If

The above process provides a dynamic identification of a valid keyword for a supplied token and thus minimises the amount of typing necessary to define a valid is command and is thus suitable for use on a mobile device.

Token Delimiters:

In many cases, a space in a command line is treated as a token delimiter. This is suitable in situations where keywords are always single words, but is not appropriate when the keyword may be a string that contains spaces. In these situations it may be necessary to use another character (such as a”,”) as a delimiter.

A set of valid substrings can be used as delimiters. For example, if the required keyword for a location parameter is made up of a suburb and a State, then the abbreviation for the State is treated as a delimiter. In this case, the set of valid abbreviations for all States acts as a delimiter.

Parameter Sequencing:

In a conventional CLI, the user is often required to know the correct order of all the parameters. In some situations it may be possible to accept parameters in any order, providing that there is no risk of confusing an abbreviation for a valid keyword in more than one set of parameter keywords. This possibility relies on the values for each parameter coming from distinct non-overlapping domains.

Required First Letter:

The method described allows any set of letters from a keyword to be used in the abbreviation, providing the sequence remains unchanged. In many situations it may be desirable to require the first letter of the abbreviation to be the first letter of the keyword.

Discretionary Use of Abbreviations:

The method described allows abbreviations to be used for all tokens within a message, including commands, parameters and switches. In some situations it may be desirable to require the user to supply the full keyword for some parameters and to allow abbreviations for only some of the parameters. This may be appropriate when the list of valid keywords is quite large and the likelihood of ambiguous abbreviations being supplied is relatively high. It is also appropriate in situations where the list of keywords is constantly being expanded and it is undesirable for an abbreviation that is unique one day to become ambiguous the next.

Alternative Keywords:

Here the list of valid keywords for a particular context includes more than one keyword for a single parameter value. This is needed in situations where different spellings or synonyms need to be supported, such as “WEST RYDE” and “RYDE WEST”. It is also desirable in situations where recognised abbreviations are likely to be used, such as “ATM” for “AUTOMATIC TELLER MACHINE”. The use of pre-defined abbreviations is also useful in situations where the use of dynamic abbreviations has been disabled. It can also be used to allow common misspellings to be processed correctly.

Processing of Abbreviations:

A number of steps are involved in processing a message from a user. The processing of abbreviations can be made at one or more stages. For example, the processing of an abbreviation for a command can be made at the point where an SMS message is converted into an HTTP request. This may be necessary if the request is sent to different servers depending on the command detected. The processing of other parameters can be made by the directory server.

Keyword Overlap:

In some situations, the set of valid keywords can overlap, such that one valid keyword is a substring of another valid keyword. This is more likely to occur in situations where the set of keywords is determined by factors outside the control of the service developer and is quite common in the case of suburb names, which are often derived from other suburb names. For example, the suburb “RYDE” is a substring within the suburbs “NORTH RYDE”, “EAST RYDE”, “WEST RYDE” and “TOP RYDE”. In these situations the supplied abbreviation is assumed to be the minimal string and additional characters must be supplied to identify the superstring variants. For example, “RYD” would be assumed to mean “RYDE” and “NRYD”, “ERYD”, “WRYD” or “TRYD” would be acceptable abbreviations for the other suburbs.

Ambiguous Requests:

In actual deployment of the system it is likely that users will occasionally provide an ambiguous abbreviation. The way in which ambiguous requests are handled depends on a number of factors, such as the cost of sending messages and the time taken to send and receive messages. In many cases, it is appropriate to choose one of the possible keywords and to process the request accordingly, but possibly include a note highlighting the ambiguity as part of the results. In other situations, it is appropriate to notify the user of the ambiguity before processing the request and to require them to clarify the request before proceeding.

Complete Validation:

As earlier described, the processing of an abbreviation stops once a single valid keyword was identified. In some situations, it is desirable to complete processing of the abbreviation to confirm that the keyword that was identified was actually correct. The complete validation of abbreviations with keywords will detect invalid abbreviations.

Reverse Abbreviations:

The refinements discussed above all relate to the processing and interpretation of the command string. In many situations it will also be appropriate to process the reply string before sending it back to the user. This may be necessary to optimise the use of limited message space. One technique for processing reply strings is the replacement of particular words in the results with abbreviations. For example, street types in an address can be replaced with recognised abbreviations, such as “ST” for “STREET” and “HWY” for “HIGHWAY”.

Elliptical Spatial Search Facility:

A further extension of the system 20 provides an Elliptical Spatial Searching Facility. Such an Elliptical Spatial Searching Facility can be used, for example, to identify entities of interest that are located between two separate geographical points.

Before describing the Elliptical Spatial Search Facility in detail, the following is provided by way of background discussion.

Hard copy business directories covering a particular geographic area (usually delimited by an area code) such as the Yellow Pages, impose a rigid, albeit large, search area on consumers, who are required to manually search the directory on the basis of category and/or business name. In some cases, this is offset by the publication of ‘community’ directories that serve an area smaller than the primary directory.

Hard copy business directories have also been converted into electronic format and distributed on compact disc. This has allowed easier searching of the content but, as with the hard copy directories, they only provide a limited amount of information for each of the businesses listed and offered searching of pre-defined areas only. Like the hard copy directories, the compact disc directories need to be replaced annually to keep the information current.

With the growth of the Internet, business directories have also been provided online. This has meant that information for an entire country can be accessed through a single website. However, although a greater amount of information can be made available, intending consumers mostly use a directory service to locate a business that is geographically convenient to them.

Most online directories allow a user (typically an intending consumer) to perform a search by state, suburb and/or adjacent suburbs. At most, this allows the user to elect to include surrounding suburbs within a nominated search area. However, these directories cannot provide the user with maximum control over the search area because the selection of areas is restricted to traditional geographic boundaries (ie. radial searching).

The growing use of wireless based information services has led to interest in location-based directory services, whereby a search query automatically includes the user's physical location, by virtue of wireless communication from a mobile device in the user's possession.

For such wireless directory services to be useful, it is desirable that the search areas be very small to cover the area immediately surrounding the user. Further, it is desirable that there is a degree of flexibility in how a search area is specified, particularly with regard to the size of the search area.

In some situations, there is a need to base a search on a particular location (search origin). However, rather than locate all of the entities of interest within a surrounding area, the user may prefer to locate only an entity that is nearest to the search origin. This requires a different search, because the nearest entity may not necessarily be within the immediate area surrounding the search origin and the user won't necessarily know what size search area is required to obtain a result. This can be achieved by increasing the search area incrementally until the required entity is found.

A variation to this type of search is to specify a minimum number of results and to keep increasing the search area until this minimum is met.

In other situations, there is a need to locate entities of interest that lie between two geographical locations. For example, if a user is planning a trip between two points and needs to know the location of entities of interest between those two points.

A variation to this type of search is to locate the entities that are nearest to the path of travel between the two locations, even if they are not directly between the two locations. For example, a user may want to know the location of petrol stations on a route between two towns. If there are no petrol stations on the specific (direct) route between the two towns there is still a need to locate the nearest petrol station even if it means a detour, which may even necessitate going backwards from the origin or past the destination town.

Other techniques used by online locator services enable users to locate entities of interest include the following:

Regional Hierarchy:

Some locator services offer searches on the basis of a regional hierarchy. These require the user to “drill-down” to the area of interest, either using a graphical interface or a series of picklists. Most often, the user starts with the country, then selects the state, then region and/or suburb of interest. The search is then performed within the specified area. This method of searching requires the user to know the actual location of their area of interest on a map or the general region of the area of interest so they are able to select the correct region using picklists. The drill-down method also means that the user must go though numerous screens until they get to the results page.

Region Matching (Post Code or Suburb):

Here, a region nominated by a user is matched with various entities within a database. This requires each entity to be identified by its suburb and/or postcode and means that the user will only get a result if the entity of interest has been identified in the database as being located within the nominated region.

Allocation Table:

This method works by pre-allocating entities to a particular region, often identified by postcode. This provides users with quick results but offers limited search capabilities. The allocation table essentially pre-calculates a single result for every possible search but has difficulty returning a list of results. These searches require the user to enter a postcode and/or suburb upon which the search is based. Some of these are based on exact searches, which means that no match will give a ‘no results’ answer.

Geocells:

Next, the concept of a “geocell” will be discussed. A geocell is a specific area defined by a set of co-ordinates. The coordinates may be grid or map references (such as in a street directory) or actual latitude and longitude measurements.

The size of a geocell depends on the grid size or the degree of precision used in measuring latitude or longitude. It is possible to define a geocell of any size by combining map grids or by using a range of coordinate values. For example, it is possible to define a geocell as being the area that lies between a minimum and maximum longitude and between a minimum and maximum latitude. A geocell can also be calculated around a given location, using the latitude and longitude of that location combined with a distance or variation in latitude or longitude.

A geocell can be used as the basis for a spatial search. For example, in a simple system, all entities of interest can be associated with a named geocell, such as their map reference. In a more sophisticated system, a geocell can be created based on a search origin and then all entities that lie within that geocell can be identified based on a comparison of their longitude and latitude in relation to the geocell.

However, a drawback in using geocells for a spatial search is that they are inherently ‘square’ in shape. As a consequence, in some cases, the results may include entities that are further away from the search origin than entities that are just outside the geocell. This situation is undesirable if the objective is to locate the nearest entity or to rank all entities based on their distance from a search origin.

Networks:

A network of locations can be created by associating each location ‘node’ with its neighboring locations. An example of a location network would be a post code network, in which each post code is linked to the adjacent post codes. Another example of a location network would be a road network, in which intersections are nodes that are joined together by links corresponding to streets. Once a network of locations has been created it is possible to associate entities of interest with an appropriate node. Network analysis techniques can then be used to provide a spatial search facility.

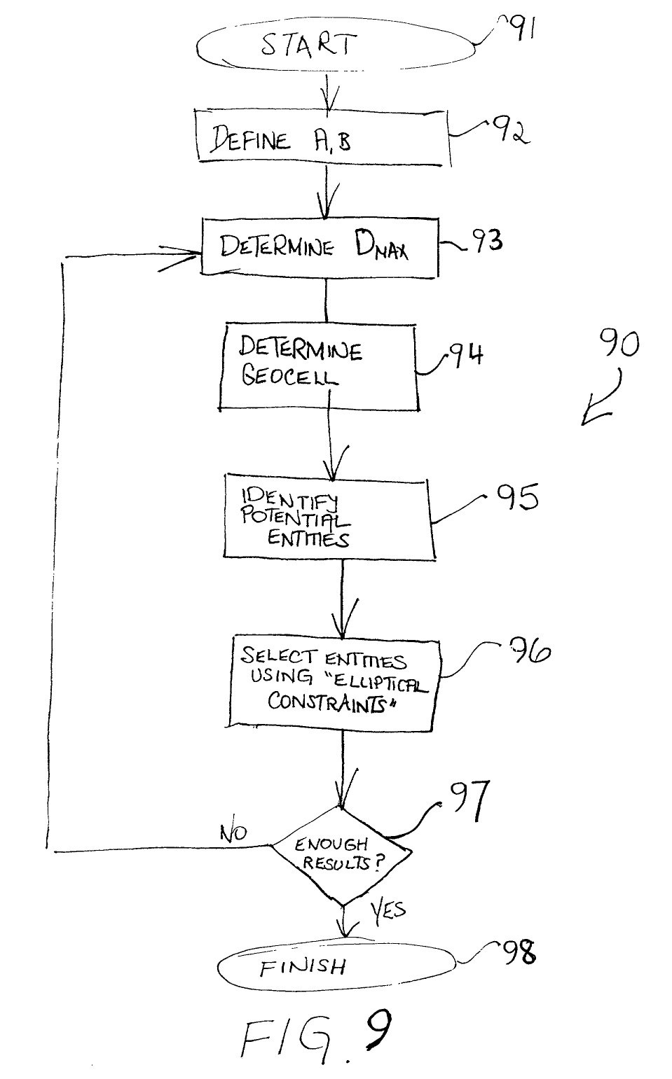

An example of a method 90 according to the Elliptical Spatial Search Facility will now be described with reference to FIG. 9.

A start step 91 commences the method 90, upon which flow of control passes to step 92.

At step 92, each of two geographical reference locations (or “focal points”) A and B are selected (or defined). For example, these two reference locations A and B may be the start and end points, respectively, of a journey intended to be undertaken.

At step 93, a maximum distance D_{MAX}, which must be greater than a linear distance, between the two reference locations A and B, is determined. D_{MAX} represents a value corresponding to the geometry of an ellipse and is described in more detail later.

Next at step 94, a geocell 100 which encloses or includes each of the two reference locations A and B is determined. The determination of this geocell 100 can be made in a number of ways, including the use of buffers as will be described later.

Passing now to step 95, all potential entities of interest, E_{geo}, are identified within the geocell 100. These potential entities of interest, E_{geo}, can be identified from the geocell 100 for example, on the basis of being a retailer that stocks a particular product.

At step 96, an elliptical search area 101 is effectively defined by either selecting or rejecting each one of the potential entities of interest, E_{geo}.

This selection or rejection step is performed according to an “elliptical constraint” as follows.

For each one of the potential entities of interest, E_{geo}, earlier identified, a distance from each of reference locations A and B is determined and added together. If this sum is less than D_{MAX}, then that particular entity is selected because it is deemed to fall within an effective elliptical search area 101. However, if this sum is greater than D_{MAX}, then that particular entity is rejected because it is deemed to fall outside the effective elliptical search area 101.

At step 97, it is determined whether the number of results returned from step 96 have reached a specific, predetermined number n.

If at step 97 this predetermined number n is not satisfied, then the effective elliptical search area 101 is increased by passing back to step 93. By repeating step 93, the effective elliptical search area 101 can be increased incrementally, until the required number n of results are obtained. This incremental search technique is further discussed later.

If at step 97 this predetermined number n is satisfied, then the method 90 is completed at step 98.

The Elliptical Spatial Search Facility can be used in combination with a database 8 and the method 30 for providing information related to various goods and services, as earlier described in relation to FIGS. 1 and 2. Effectively, this can provide users with a dynamic interface for conducting searches as part of a business directory or a trip planning facility.

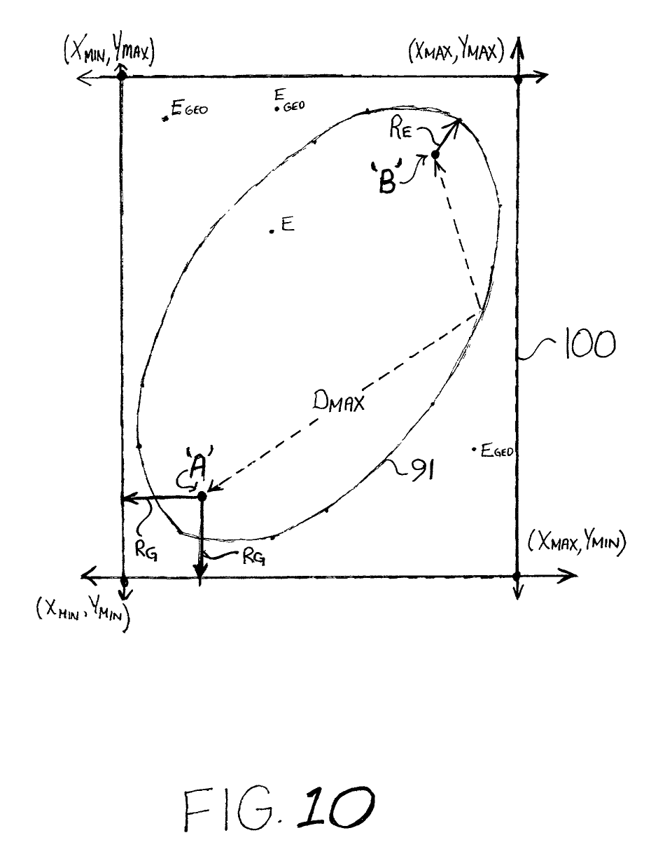

Turning now to FIG. 10, an exemplary diagrammatical explanation for determining the geocell 100 which encloses (or includes) each of the two geographical reference locations A and B is provided.

The geocell 100 is delimited by the inclusion of a buffer RG around each of the two reference locations A and B. The value of the buffer RG can be based on a fixed distance, or can be proportional to a linear distance between the two reference locations A and B.

In situations where the value of the buffer R_{G} is proportional to the linear distance D_{AB} between the two reference locations A and B, a grid factor F_{G} is firstly defined as follows:

F_{G}=size of buffer (R_{G})/distance between two points (D_{AB})

The value of the grid factor F_{G} can range between 0 and 1, depending upon the context of the desired search. However, a typical value of F_{G} is between 0.1 and 0.01.

In a Cartesian coordinate system, given two points A (Aₓ, A_{y}) and B (Bₓ, B_{y}) and a grid factor F_{G}, the value of the buffer R_{G} can be calculated as follows:

R_{G}=F_{G} * sqrt((Aₓ−Bₓ)ˆ 2+(A_{y}−B_{y})ˆ 2)

The coordinates for the enclosing geocell according to the Cartesian coordinate system can then be calculated as follows:

Xₘᵢₙ=Min(Aₓ,Bₓ)−R_{G}

Yₘᵢₙ=Min(A_{y},B_{y})−R_{G}

Xₘₐₓ=Max(Aₓ,Bₓ)+R_{G}

Yₘₐₓ=Max(A_{y},B_{y})+R_{G}

In a Cartesian coordinate system, the units of measure are the same for both the X and Y axis, so the value of the buffer R_{G} can be applied to both axes without modification.

In many real world situations, geographic locations are specified using longitude and latitude. In such a spherical coordinate system, the distance D_{AB} between each of the two reference locations A and B can be calculated using the following equations:

Aₓᵣ=DegToRad(A_{iong})

A_{yr}=DegToRad(Aₗₐₜ)

Bₓᵣ=DegToRad(B_{long)}

B_{yr}=DegToRad(Bₗₐₜ)

D_{AB}=2*a sin (sqrt((sin((B_{yr}−A_{yr})/2))ˆ 2+cos(B_{yr})*cos(A_{yr})*(sin ((Bₓᵣ−Aₓᵣ)/2))ˆ 2))*R_{W}

where:

all angular measurements are in radians, and

R_{W} represents the ‘great circle’ approximation for the radius of the earth.

An alternative way of calculating the enclosing geocell, defined by its vertices (G_{long1}, Gₗₐₜ₁) and (G_{long2}, Gₗₐₜ₂), is to calculate two interim geocells around A and B. In a spherical coordinate system (A_{long}, Aₗₐₜ), (B_{long}, Bₗₐₜ), this becomes:

R_{G}=F_{G}*D_{AB}

Aₗₐₜ₁=RadToDeg(DegToRad(Aₗₐₜ)−R_{G}/R_{W})

Aₗₐₜ₂=RadToDeg(DegToRad(Aₗₐₜ)+R_{G}/R_{W})

Bₗₐₜ₁=RadToDeg(DegToRad(Bₗₐₜ)−R_{G}/R_{W})

Bₗₐₜ₂=RadToDeg(DegToRad(Bₗₐₜ)+R_{G}/R_{W})

A_{long1}=RadToDeg(DegToRad(A_{long})+2*a sin(sin(R_{G}/(2*R_{W}))/cos(DegToRad(Aₗₐₜ))))

A_{long2}=RadToDeg(DegToRad(A_{long})−2*a sin(sin(R_{G}/(2*R_{W}))/cos(DegToRad(Aₗₐₜ))))

B_{long1}=RadToDeg(DegToRad(B_{long})+2*a sin(sin(R_{G} /(2*R_{W}))/cos(DegToRad(Bₗₐₜ))))

B_{long2}=RadToDeg(DegToRad(B_{long})−2*a sin(sin(R_{G}/(2*R_{W}))/cos(DegToRad(Bₗₐₜ))))

Gₗₐₜ₁=Min(A_{lat1,}Bₗₐₜ₁)

Gₗₐₜ₂=Max(A_{lat2,}Bₗₐₜ₂)

G_{long1}=Min(A_{long1,} B_{long1,} A_{long2,} B_{long2})

G_{long2}=Max(A_{long1},B_{long},A_{long2,}B_{long2})

This has the effect of generating an enclosing geocell, the coordinates of which exceed the two reference locations A and B, by a distance calculated using the grid factor F_{G}.

A more detailed algorithm for preparing a list of the potential entities of interest, E_{geo} from the enclosing geocell will now be described.

Given an enclosing geocell (Gₓₘᵢₙ, G_{ymin}, Gₓₘₐₓ, G_{ymax}), the potential entities of interest, E_{geo}, are those where Gₓₘᵢₙ [symbol] Eₓ [symbol] Gₓₘₐₓ and G_{ymin} [symbol] E_{y} [symbol] G_{ymax}.

Hence:

For each entry in complete list

Determine Eₓ and E_{y}

If (Eₓ<Xmᵢₙ) OR (Eₓ>Xₘₐₓ) OR (E_{y}<Yₘᵢₙ) OR (E_{y}>Yₘₐₓ), then

Remove entry from list of potential entries

Endlf

Next

A more detailed algorithm for applying the elliptical filter to the list of potential entities from an enclosing geocell will now be described.

An ellipse is a locus of points for which the sum of the distances from each one of those points, to two fixed, focal points, is equal. To determine if a test point such as any one of the earlier identified potential entities, falls within the ellipse 91, its distance from both reference locations A, B is calculated. The two distances from each of the reference locations A, B are then added together and compared with the distance D_{MAX}, which creates the locus of the ellipse and can be expressed as:

D_{MAX}=D_{AB}+2R_{E,}

where R_{E} is the distance between the focus and the locus, along the line of the major axis of the ellipse 91.

R_{E} may be a fixed value or it may be calculated based on the distance between A and B using an ellipse factor F_{E}, where:

R_{E}=F_{E}*D_{AB.}

This has the effect of defining an ellipse that goes beyond the two points A and B by a distance of no more than R_{E}.

The method for calculating the distance between an entity and the two reference locations A, B may depend on the coordinate system being used. The formulas for calculating this distance for the Cartesian and Spherical coordinate systems are given above.

Once the distance between each entity and the two reference locations A, B has been calculated, it is a relatively simple task to identify the entities that meet the specified requirements:

D_{AEB}=D_{AE}+D_{EB}

If the value of D_{AEB} is less than the value of D_{MAX} originally specified, then the entity lies within the ‘elliptical constraint’, otherwise it is discarded.

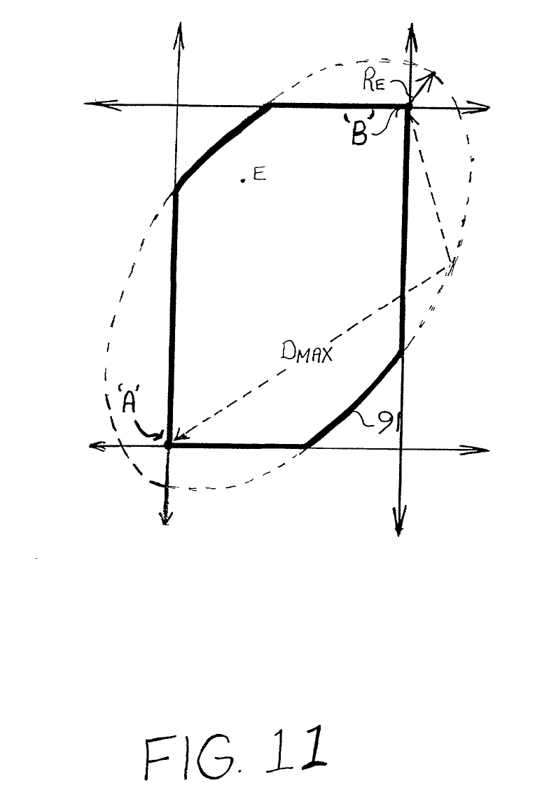

In an alternative arrangement, the two reference points A and B form vertices of the enclosing geocell. A diagrammatical example is shown in FIG. 11. Note that the grid factor F_{G} is zero.

Further refinements to the foregoing method 90 of the Elliptical Spatial Search Facility will now be described.

Minimum Values:

Sometimes, the use of grid factor F_{G} and/or an ellipse factor F_{E} to determine the search area may not deliver satisfactory results. This occurs when the resulting value of R is too small to give a sensible result, such as in the following examples:

(i) Grid Factor of Zero:

In situations where a grid factor F_{G} of close to zero is used, the geocell approaches being defined using the two locations A and B as vertices. In some situations this creates a search area that would not deliver satisfactory results, for example, where B is directly above A, the search area would have a negligible width.

(ii) Ellipse Factor of Zero:

In situations where an ellipse factor F_{E} of close to zero, then the corresponding ellipse approaches a straight line between the two points. For large distances this may still define an area that is reasonable, but for smaller distances the area becomes too small to be useful.

(iii) Coincident Points:

In situations where A and B are very close together (or on the same point) the values for R_{G} and R_{E} become very small. This results in a search are that is too small to be useful.

In each of the above situations, a minimum value of R_{G} and/or R_{E}, referred to as R_{Gmin} and R_{Emin} may be required to return a meaningful result. It would not always be necessary for Rₘᵢₙ to be applied in both orientations. By introducing the concept of a minimum value for R_{Gmin} and/or R_{Emin}, the system will always generate a reasonable search area. In the case of coincident points, R_{G} and/or R_{E} become the radius for a circle around the coincident point.

Incremental Search:

Here the elliptical search area is increased incrementally until a requisite number of results are obtained. For example, this could be necessary where the user needs to locate the closest entity of interest and does not know how far away that entity is. A series of searches is carried out by incrementally adjusting the value of R until a minimum number of results are returned. A maximum value of R is required to represent the maximum search area to be considered, otherwise a search where there are no valid results would end in an infinite loop.

An example of an algorithm for an incremental search that also uses using a minimum value of R for both R_{G} and R_{E} is as follows:

Calculate D_{AB}

Rg=Fg*D_{AB}

Re=Fe*D_{AB}

For R=Rₘᵢₙ to Rₘₐₓ

If Rg<R then Rg=R

If Re<R then Re=R

Calculate enclosing geocell for A, B using Rg

Determine potential entities

Filter entities using A, B and Re

If minimum number of results obtained then exit

Next R

A refinement of the above algorithm involves the use of an incremental step size for R that varies as the search area increases. For example, it may be appropriate to use 1 km increments for values of R between 1 km and 10 km, 10 km increments between 10 km and 100 km, and 100 km increments between 1,000 km and 10,000 km. In most situations, a maximum value for R of 10,000 km is sufficient.

A further refinement resides in differentiating between results obtained on first and subsequent iterations of the search. This can indicate to users the varying relevance of the results and is particularly useful in situations where the user needs to locate entities of interest between two points and would benefit from knowing which entities listed in the results would require greater deviation from the intended route.

Intermediate Points:

In some cases, a single ellipse between two end points does not give an optimal result. For example, if the road does not follow closely the straight line between the two towns or there is a barrier such as a waterway between the two points that prevents a straight line approximation being sensible. In these cases, it may be appropriate to consider intermediate points and to apply the spatial search to each ‘leg’ of the ‘journey’ in turn. The number of intermediate points required may depend on the actual connections between each point. The intermediate points can be nominated by the user or determined by the system.

Networks:

The method could be applied to locations that are part of a defined network of nodes and links. In this situation the system could use network analysis techniques to determine the intermediate points and then apply the spatial search to each pair of intermediate points. In this way the locations would need to be part of the network that is modeled, but the entities of interest do not need to be part of the network.

The foregoing describes only a number of embodiments of the present invention, and modifications can be made thereto without departing from the scope of the present invention. For example, the system could be implemented using software running on a server on a wide area network or a local area network, or on software supplied for instance on compact disc, running on a personal computer. Also, access to the system by the consumer could be had with the help of a third party operating, for instance, a central call centre.

Although the method is primarily intended to provide price comparisons for products that the consumer will subsequently purchase from physical retail outlets, it can also include prices for products that can be purchased from virtual retail outlets. In this way, most of the features of existing methods can be provided, plus additional features that relate to the location of products that meet geographical criteria.

Further, whilst the foregoing description is focused upon products such as retail goods for domestic consumption, other goods such as those for commercial consumption may be handled. Further, the products need not be specific goods, but for example services to be provided to the user. Such services may include legal, medical and dental services, and many others.

A number of aspects of the present invention, which are intended to identify, but not necessary limit, the scope of the present disclosure, are summarised in the following claims.

1. A product information distribution system comprising:
a database having records of user purchasable products, each said record including fields for at least identification and geographical availability of said product,
an input means for receiving input data from a user related to a preferred product which is selected from one of said product identification fields of said records, a distance value and a preferred geographical location from which said preferred product is to be sourced,
searching means for searching said database according to said input data and for determining a search result, said search result relating to those of said records including products meeting said product identification fields and available within a boundary determined by said distance value of said preferred geographical location, and
an output display means for displaying said search result to said user.

2. A product information distribution system as claimed in claim 1, wherein said preferred geographical location is a co-ordinate value and said boundary is determined by a radius thereabouts corresponding with said distance value.

3. A product information distribution system as claimed in claim 1, wherein said geographical location is in longitudinal and latitudinal form.

4. A product information distribution system as claimed in claim 1, wherein each said record of user purchasable products further includes at least one product attribute field and said input data is further related to said product attribute field.

5. A product information distribution system as claimed in claim 4, wherein said search result can be sorted by the user on the basis of said product attribute field.

6. A product information distribution system as claimed in claim 1, wherein each said record of user purchasable products further includes a pricing field and said input data is further related to said pricing field.

7. A product information distribution system as claimed in claim 6, wherein said search result can be sorted by the user on the basis of said pricing field.

8. A product information distribution system as claimed in claim 1, wherein said database and said searching means is accessible over the Internet by a user of said input means.

9. A product information distribution system as claimed in claim 1 wherein said search result can be sorted by the user on the basis of said distance value.

10. A computerised system comprising:
an input means for receiving input data including a user-selected market entity, a reference geographical location, and a maximum deviation from said reference geographical location,
an output means for displaying information to the user, and
a memory means including an executable user-interface program for operatively controlling said input means and said output means, a database of records including an identity and geographical availability for each of a plurality of market entities, and an executable searching program for searching said database for records that correlate with said input data and for enabling said records that correlate to be displayed as information on said output means.

11. A system as claimed in claim 10, wherein said database of records further includes current pricing information for each of said plurality of market entities, said current pricing information being outputted from a temporal test program being executed prior to an execution of said searching program.

12. A system as claimed in claim 11, wherein said database of records further includes temporally independent pricing information for each of said plurality of market entities, said temporally independent pricing information being inputted to said temporal test program and being transparent to said searching program.

13. A system as claimed in claim 12, wherein said temporally independent pricing information is accessible by said suppliers of said of the user purchasable products.

14. A method of facilitating Internet-assisted commerce, said method comprising the steps of:
collecting a plurality of retailer related records, each of said retailer related records including a product code, and a related geographical availability in longitudinal and latitudinal form,
storing said plurality of retailer related records in searchable form,
providing a means for selectively retrieving one or more particular retailer related records based upon a user entered product code and a maximum allowed deviation from said geographical availability.

15. A system for distributing information related to user purchasable products, said system comprising:
a database of records including fields related to identification, pricing, characterisation and geographical availability of a plurality of user purchasable products, said records also including fields related to a plurality of suppliers of the user purchasable products,
input means for receiving user input data related to at least a desired characterisation and geographical availability of a desired user purchasable product,
searching means for searching said database on the basis of said user input data and for determining a search result, said search result having records including said fields related to identification, pricing and supplier, and
an output display means for displaying said search result.

16. A system as claimed in claim 15, wherein said fields relating to pricing are associated with a temporary storage element, the data within which is periodically checked according to temporal statement and if said check is true, then 0 said data is loaded into said associated field related to pricing.

17. A system as claimed in claim 16, wherein an authorised supplier can access one or more temporary storage elements.

18. A computerised method of distributing product information, said method comprising the steps of:
tendering a plurality of product types, for selection of one desired product type by a user,
tendering a plurality of product sub-types on the basis of the selected product type, for selection of one desired product type by the user,
tendering at least one or more relevant characterising product attributes, on the basis of the selected product type, for selection of one or more attribute preferences by the user,
obtaining geographical data related to an acceptable geographical purchasing area by the user, and
returning any of a plurality of pre-stored data records which correlate to all of said selections and said acceptable geographical purchasing area.

19. A method of dynamically constructing a searchable index of valid identifiers, said method comprising the steps of:
(i) prompting a user for an initial word;
(ii) building a set of possible valid identifiers based on said initial word and previously mapped relationships with respect to said initial word;
(iii) displaying said set for selection by the user,
(iv) adding the initial word to a list of unmatched words, prompting the user for a new initial word and repeating from step (ii), if a selection from said set has not been made by the user;
(v) providing a further mapped relationship for each of said list of unmatched words with a selected valid identifier, if a selection from said set is made by the user.

20. A method of facilitating Internet-assisted commerce as claimed in claim 14, wherein the user entered product code is taken from a searchable index of valid identifiers dynamically constructed with the steps of:
(i) prompting a user for an initial word;
(ii) building a set of possible valid identifiers based on said initial word and previously mapped relationships with respect to said initial word;
(iii) displaying said set for selection by the user,
(iv) adding the initial word to a list of unmatched words, prompting the user for a new initial word and repeating from step (ii), if a selection from said set has not been made by the user;
(v) providing a further mapped relationship for each of said list of unmatched words with a selected valid identifier, if a selection from said set is made by the user.

21. An indexing system comprising:
means for obtaining an initial word of interest;
a database for storing words and any related alternative words, each of said stored words being searchable on the basis of a mapped relationship with the initial word of interest; and
means for mapping and storing newly related words to said database where a search of the database cannot determine a mapped relationship with the initial word of interest.

22. A method for classifying information related to a plurality of identified entities, said method comprising the steps of:
creating a uniquely identifiable record of information related to each of said entities;
determining a rule for tagging each of said records, said rule including assignment of at least two related and independently interpretable indexable tags for each of said records; and
searching for one or more of said indexable tags on the basis of desired values of said indexable tags.

23. A method as claimed in claim 22, wherein at least one of said indexable tags relates to an attribute of said entity.

24. A method as claimed in claim 23, wherein at least one of said indexable tags relates to an identification type of said entity.

25. A method as claimed in claim 24, wherein a common rule is determined for entities having a common identity type.

26. A method as claimed in claim 1, wherein said distance value is entered by said user.

27. A computerised system as claimed in claim 10, wherein said maximum deviation is user-selected.

28. A computerised system as claimed in claim 27, wherein said reference geographical location user-selected.

29. A method of facilitating Internet-assisted commerce as claimed in claim 14, wherein said maximum allowed deviation is user entered.

30. A computerised method of distributing product information as claimed in claim 18, wherein said geographical data related to an acceptable geographical purchasing area by the user, is obtained by user selection.

31. A method as claimed in claim 25, wherein said entities are market entities comprising at least one selected from the group consisting of consumer products, organisations, services, people, documents and media.

32. A method of enabling a query to be performed on a database holding records of information related to marketable entities, said method comprising the steps of:
receiving data related to a desired type of market entity,
determining one or more searchable attribute fields of relevance to the desired product type, and
generating a query form having data entry fields for each of said determined searchable attribute fields, said query form being arranged for entry of value data by a user of the database.

33. A method as claimed in claim 32, further comprising the steps of:
receiving value data from at least one of said data entry fields on said query form having been filled by a user of the database, and
executing a corresponding query on the records of the database.

34. A method for classifying and subsequently retrieving product related information, said method comprising the steps of:
displaying a product pick list to an intending consumer,
receiving a product selection from said product pick list from the intending consumer,
determining a set of attribute fields associated with said product selection,
displaying an attribute field pick list to the intending consumer,
receiving an attribute field selection and a value for one or more of said attribute fields,
determining product related information in accordance with said received selection and value, and
displaying said product relation information.

35. A method of generating and providing an instruction for querying a database holding records of information related to marketable entities, said method comprising the steps of:
keying a command as an input text message into a wireless mobile device;
incorporating context data into said message to form said instruction; and
forwarding said instruction to said database.

36. A method as claimed in claim 35, wherein the mobile device is a mobile telephone handset and at least said message is formed according to SMS protocol.

37. A method as claimed in claim 35 or 36, wherein said context data is keyed into said mobile device.

38. A method as claimed in claim 37, wherein said context data is related to a physical location.

39. A method as claimed in claim 35 or 36, wherein said context data is automatically incorporated into said message.

40. A method as claimed in claim 39, wherein said context data is selected from the group consisting of: physical location, user telephone number, and a time of day.

41. A method as claimed in claim 36, further comprising the substep of converting the message from SMS format to HTML format to form said instruction.

42. A system for distributing information to consumers related to market entities, said system comprising:
input means for receiving input query information from a consumer related to a preferred market entity;
adjustment means for adjusting said input query information with one or more instances of context information to create input data;
searching means for searching a database of records for matches that correlate with said input data,
output means for outputting said matches, and
a wireless communication path for communicating said input query information or said input data between said input means and said searching means via said adjustment means.

43. A system as claimed in claim 42, wherein said wireless communication path includes the use of SMS protocol.

44. A system for distributing information as claimed in claim 42 or 43, wherein said context information is selected from the group consisting of geographical location data, user telephone number and a time of day.

45. An apparatus for converting a text message into an instruction for querying a database, said apparatus comprising:
receiving means for receiving a text message having originated from a mobile hand held user operable device, said receiving means further for receiving a context parameter associated with the text message; and
converting means for converting the text message and the context parameter, into an instruction for querying a database.

46. An apparatus as claimed in claim 45, wherein the text message comprises at least a query component and said context parameter is entered by the user as a further component of the text message.

47. An apparatus as claimed in claim 45, wherein the context parameter is automatically generated by the user operable device and forwarded to the receiving means.

48. An apparatus as claimed in claim 47, wherein the automatically generated context parameter relates to one or more selected from the group consisting of: physical location, user telephone number, and a time of day.

49. An apparatus as claimed in claim 45, wherein the context parameter is generated at said apparatus.

50. An apparatus as claimed in claim 45, wherein said converting means converts at least said text message from SMS format to HTML format.

51. A method of preparing a command for inputting to a digital computer, said method comprising the steps of:
(a) receiving and storing an input character;
(b) scanning a set of valid abbreviations for a match with said character;
(c) repeating steps (i) and (ii) until a match is found;
(d) correlating said match with a keyword and constructing said command including at least said keyword; and
(e) transmitting said command over a wireless network to the digital computer.

52. A product information distribution system as claimed in claim 1, wherein said input data includes a time of day value and said search result includes including records matching said time of day value.

53. A computerised system comprising:
an input means for receiving input data including a user-selected market entity, at least one reference geographical location, and a time of day;
an output means for displaying information to the user, and
server means including an executable user-interface program for operatively controlling said input means and said output means, a database of records including an identity and geographical availability for each of a plurality of market entities, and an executable searching program for searching said database for records that correlate with said input data and for enabling said records that correlate to be displayed as information on said output means.

54. A method of defining a geographical area for computerised searching of market entities, said method comprising the steps of:
defining a pair of geographical reference locations;
determining a distance value being greater than a linear distance between said pair of geographical reference locations; and
defining said geographical area by applying a rule that excludes entities that have a sum of a distance to each of said reference locations being greater than said distance value.

55. A method as claimed in claim 54, wherein said distance value is less than twice the value of the linear distance.

56. A product information distribution system comprising:
a database having a record for each of a plurality of user purchasable products, each said record including fields for at least identification and geographical availability of said corresponding product,
input means for receiving input data from a user related to a preferred product which is selected from one of said product identification fields of said records, a distance value and two user input geographical locations from between which said preferred product is to be sourced,
searching means for searching said database according to said input data and for determining a search result, said search result relating to those of said records including products meeting said product identification fields and available within a boundary determined by the method according to claim 38, and
an output means for displaying said search result to said user.

57. A method of identifying entities of interest according to their geographical location, said method comprising the steps of:
defining at least two geographical reference locations;
determining a geocell enclosing said at least two reference locations;
determining an elliptically shaped region being within said geocell and including each of said at least two locations; and
identifying entities of interest from within said region.
